(19) United States
(12) Patent Application Publication
(10) Pub. No.: US 2002/0030840 A1
(43) Pub. Date: Mar. 14, 2002

(54) Image output system, and device and method applicable to the same

(75) Inventors: Kanji Itaki, Yokohama-shi (JP); Masahiro Machida, Ebina-shi (JP); Toshihide Yoshimura, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 09/950,028

(22) Filed: Sep. 12, 2001

(30) Foreign Application Priority Data
Sep. 19, 2000 (JP) 2000-284302
Jun. 29, 2001 (JP) 2001-200082
Sep. 19, 2000 (JP) 2000-284368
Jun. 29, 2001 (JP) 2001-198736
Sep. 19, 2000 (JP) 2000-284300
Jun. 29, 2001 (JP) 2001-200081
Sep. 12, 2000 (JP) 2000-277180
Jun. 29, 2001 (JP) 2001-198737
Sep. 19, 2000 (JP) 2000-284301
Jun. 29, 2001 (JP) 2001-199175

(51) Int. Cl. G06F 15/00; B41B 1/00

(52) U.S. Cl. 358/1.13; 358/1.15

(57) ABSTRACT

A method of displaying a screen for operating a plurality of image output devices that each have different attributes, the method comprising the steps of: performing a logical operation of the attributes of the image output devices; and displaying a screen based on the result of the logical operation. A common operation screen can be used for a plurality of image output devices having different attributes, and the logical sum and the logical product of the attributes owned by the image output devices are displayed on the operation screen, whereby the operation screen can be efficiently operated.

### BACKGROUND OF THE INVENTION

1. Field of the Invention

The present invention relates to an image input device, a user interface device, an input control device, an operation screen displaying method, an input control method, an image output system, an image output managing device, and a method of registering an image output device group, and more particularly to an image output system equipped with plural printers connected to a network, a scanner for reading out an image from an original and a printer server, and to an image input device, a user interface device, an input control device, an operation screen displaying method, an input control method, an image output managing device and an image output device group registering method which are applicable to the image output system.

2. Description of the Related Art

In a conventional copying machine, an image of an original mounted on a table for the original is read by a CCD (Charge Coupled Device). A latent image is recorded on a photosensitive drum on the basis of the image thus read, using a semiconductor laser. Then the latent image on the photosensitive drum is developed and transferred onto a sheet by using an electrophotographic process, thereby outputting an image. This copying machine may be equipped with a compact display panel which has a liquid crystal display panel and a touch panel overlaid on a display panel as user interface. The amount of information that can be simultaneously displayed at the display panel and the density of information that can be set on the display panel are restricted.

Further, when a network printer is constructed by connecting plural printers to a network to thereby enable the respective printers to output images, it is to be expected that the network printer structure includes a scanner as a reading device for reading an image from an original and a printer server for conducting proper processing on image data received from the scanner and then transmitting the image data thus processed to a designated printer. Usually, only one scanner is connected to the network, and it has the same image reading function as a standalone copying machine. In order to output images efficiently, it may be expected that the scanner is equipped with the same type of display panel as the display panel provided as a user interface on the copying machine. A user can designate a printer from which an image is to be output and also an output format of the image. However, the display panel equipped to the conventional scanner has limitations in the amount of information that can be displayed at one time and the density of settable information. Therefore, even if a display panel of the type equipped to a standalone copying machine is directly applied to a network printer structure, the panel does not work efficiently.

In general, plural printers having different attributes such as types, functions, makers, network addresses, etc. are connected to a network, and it is necessary that different output instructions are made from a specific place to the various types of printers having different attributes, to enhance image output efficiency. However, in order to implement such a system, it is required that operation screens corresponding to the respective types of printers are displayed on the display panel. As the number of types of printers is increased, the number of types of operation screens is also increased. Therefore, it is more difficult to operate the operation screen efficiently.

On the other hand, a saturation may be considered where the same types of printers are connected to a network so that the operation screen displayed on the display panel is used in common. However, even when plural printers produced by the same maker are connected to a network, monochromatic (black and white) printers and color printers, and printers that are different in resolution, must be used in a mixed environment. Therefore, it is difficult to make the operation screen common to all printers.

Further, in a case where printers having different functions are connected to a network in a mixed environment, when a user wants to achieve prints in the same output format on the basis of the same image data from plural printers, the printers from which the prints should be output cannot be selected unless the user knows which printers have the same functions. Further, in some cases it is necessary to search for printers having a special function such as outputting an image on a non-standard size sheet or the like.

In a case where plural printers having different attributes, for example, a monochromatic printer and a color printer, or printers that are different in resolution, are instructed to execute respective jobs, if a problem occurs at one printer and thus it is impossible for that printer to carry out a print operation, the other printer(s) cannot carry out the print job in place of the problem printer.

Further, a hard or soft reset button is mounted on a conventional copying machine or on an operating portion for adjusting various settings of the copying machine. All the setting values are returned to initial values (the initial state when the copying machine was shipped) when the reset button is operated by a user.

Recently, networking has become common in offices, etc., and it has been required to structure a print system having a multi-output function, in which a scanner for inputting image data, plural printers for outputting sheets and the like on which images are recorded on the basis of the image data, and a server for managing these devices are connected to a network.

In such a print system, image data is transmitted to the server and an image output destination is designated from an input side, and this information is registered in the server as a job. In the server, one or plural printers designated as the output destination are selected according to the job thus registered, and the printers are operated to output images on the basis of the image data.

Accordingly, when printing is carried out by the print system, it is required to carry out a two-stage setting process, that is, a first setting process of setting an output method regarding whether image output is carried out by only one printer, by plural printers with a designated number of copies being output, wherein the copies are equally divided and shared between the printers (equally-shared output), or by plural printers with the designated number of copies being output in full from each printer (multiple output), and also setting output destination printers, and then a second setting process of setting detailed information on output format (monochromatic printing/color printing, resolution, sheet size, etc.) of images to be output from the printers designated as the output destination.

However, the conventional reset button control does not support the above two-stage setting. For example, if a part of the setting of the printer designated at the output destination, for example, setting of a double-sided function (one sided printing/double-sided printing) is erroneously carried out, it is not possible to reset only the information on the image output format to initial values, and the settings of the output and designated output destination printer(s) are also returned to initial values. Therefore, an operator must re-do all settings from the beginning, and this is inconvenient in terms of operability.

Further, such a print system may be constructed so that the same type of display panel as that provided as a user interface at a standalone copying machine is equipped to the scanner and various kinds of operation screens are displayed on the display panel for carrying out the setting process of indicating printer(s) from which images are to be output, output format, etc. With the print system thus constructed, a user may designate output destination(s) of images and output formats, transmit the image data from the scanner to the server, and register this information in the server as a job. In the server, one or plural printers serving as output destinations are selected according to the registered job, and the printers thus selected are operated to output the image on the basis of the image data and the output format.

By enabling plural printers to be designated as image output destinations as described above, copies can be printed with the print operation thereof being shared by the plural printers (for example, when twenty copies of an original image are output in a monochromatic mode, each of four monochromatically-printing printers prints five copies, or the like), thereby enhancing the efficiency of the printing work.

As described above, various kinds of printers having different attributes such as the machine types, the functions, the makers, the network addresses, etc. are generally connected to a network. This print system is generally required to have a function of registering plural printers as one group in accordance with an attributes. If printers having the same attribute are registered as a group by utilizing the above function, an output destination can be easily selected by selecting a group of printers having an attribute suitable for an image to be output at the time of a printing operation and designated from the printers belonging to the group. That is, a printer suitable for the image to be output can be easily designated.

However, when an operator selects printers to be grouped (grouping target printers) from all printers connected to a network and instructs grouping of these printers in a group registration process, as the number of printers connected to the network increases, the load of the selecting work increases. In addition, there is also a problem that an operator may erroneously select a printer for a group, such as a case where, for example, in spite of an operator's intention of selecting three color printers, a monochromatic printer is erroneously included in the selected printers, and thus desired image output cannot be obtained.

Still further, if the user designates a printer from the display panel equipped to the scanner and instructs the printer to output an image, to check the job status of the printer thus designated, it is necessary to display the job list on the display panel of the printer and check the job list there. In addition, when the job of the printer is to be stopped, cancelled or the like, it is necessary to operate the operation screen displayed on the display panel of the printer. Therefore, the user must go to the place at which the printer is disposed, and find the job in the job list there, and thus there is a problem that it is very cumbersome to check or stop the job.

### SUMMARY OF THE INVENTION

The present invention has been implemented to solve the above problems, and has the following objects:

(1) to provide an operation screen displaying method, an image input device, an image output managing device and an image output system with which a common operation screen can be used for plural image output devices having different attributes and the operation screen can be operated efficiently;

(2) to provide a user interface device, an image input device, an image output managing device and an image output system that can prevent a job from erroneously being sent to an image output device incapable of outputting the job;

(3) to enhance the operability of a setting process for output operations in an image output system equipped with plural image output devices;

(4) to provide an image output system, an image input device, a managing device and a method of registering an image output device group with which image output devices having the same attribute can be easily and accurately registered as a group;

(5) to provide an image input device and an image output system with which a job status of each image output device can be easily checked when plural image output devices having different attributes are instructed to executes job; and

(6) to provide an image input device and an image output system with which control of a job (start, stop, resume, alter or delete) of each image output device can be easily carried out when plural image output devices having different attributes have been instructed to execute jobs.

In order to attain the above objects, a first aspect of the present invention is a method of displaying a screen for operating a plurality of image output devices that each have different attributes, the method comprising the steps of: performing a logical operation of the attributes of the image output devices; and displaying a screen based on the result of the logical operation.

In the operation screen displaying method, the logical operation may be set to AND or OR operation. Further, the logical operation may be carried out every attribute item of the plural image output devices.

A second aspect of the present invention is an image input device for use in an image output system, wherein the image output system includes plural image output devices connected to a network and outputs images on the basis of image data and image output format information transmitted through the network, the image output system further including an image output managing device connected to the network, which transmits an operation screen generating signal to generate, on the basis of the attribute information of each of the plural image output devices, at least one of a first operation screen for displaying attribute information common to plural image output devices satisfying a designated condition and a second operation screen for displaying all the attribute information of the plural image output devices satisfying the designated condition, and transmits information on the output format of an image received through the network and the image data to a designated image output device, wherein the image input device includes: an image data input device for inputting the image data; a display input device for inputting information to designate a condition for an operation screen to be displayed, displaying thereon at least one of the first operation screen for displaying the attribute information common to the plural image output devices satisfying the designated condition and the second operation screen for displaying all the attribute information of the plural image output devices satisfying the designated condition generated on the basis of the operation screen generating signal, and inputting, from the displayed operation screen, information to designate an image output device from which the image is output and information on the output format of the image to be output from the designated image output device; and a transceiver that is connected to the network and transmits the information input from the display input device and the image data input from the image data input device through the network and also receives the operation screen generating signal through the network.

In the image input device, when the number of attribute information items to be displayed on the operation screen is equal to a predetermined value or more, the attribute information items over the predetermined value can be displayed under an attribute item. Further, by providing an interface part for displaying the attribute item, the attribute information items over the predetermined value can be displayed in detail in accordance with an operation to the interface part.

A third aspect of the present invention is an image output managing device for use in an image output system including: plural image output devices that are connected to a network and output images on the basis of image data and information on image output formats transmitted through the network; an image data input device for inputting the image data; a display input device for inputting information to designate a condition for an operation screen to be displayed, displaying thereon at least one of a first operation screen for displaying attribute information common to plural image output devices satisfying a designated condition and a second operation screen for displaying all the attribute information of the plural image output devices satisfying the designated condition, the first and second operation screens being generated on the basis of an operation screen generating signal, and inputting, from the displayed operation screen, information to designate an image output device from which the image is output and information on the output format of the image to be output from the designated image output device; and a transceiver that is connected to the network and transmits the information input from the display input device and the image data input from the image data input device through the network to the image output managing device and also receives a signal to generate the operation screen through the network, wherein the image output managing device is connected to the network, transmits an operation screen generating signal for generating at least one of the first operation screen for displaying the attribute information common to the plural image output devices satisfying the designated condition and the second operation screen for displaying all the attribute information of the plural image output devices satisfying the designated condition on the basis of the attribute information of each of the plural image output devices, and transmits the information on the output format of the image and the image data received through the network to a designated image device.

In the image output managing device, when all the attribute information items owned by plural image output devices satisfying the designated condition are displayed on the operation screen, one image output device is selected from the plural image output devices on the basis of the information on the image output format input from the operation screen.

A fourth aspect of the present invention is an image output system comprising: a plurality of image output devices connected to a network that output images on the basis of image data and image output format information transmitted through the network; an image data input device for inputting the image data; a display input device for inputting information to designate a condition, in response to a signal for displaying thereon an operation screen for the image output devices of at least one of a first operation screen displaying attributes common to the image output devices satisfying the condition, and a second operation screen displaying all attributes of the image output devices satisfying the condition, and inputting from the displayed operation screen, information to designate from which image output device to output an image and output format information for the image to be output from the designated image output device; and a transceiver and image output managing device connected to the network, wherein the image output managing device transmits the signal, and the transceiver receives the signal and transmits image data and information input from the display and image data input devices through the network to the image output managing device, and the image output managing device transmits the image data and information to a designated image output device.

In each aspect of the present invention, the plural image output devices, the image output managing device and the image input device including the image data input device, the display input device and the transceiver are connected to the network. The image output managing device generates, on the basis of the attribute information of each of the plural image output devices, the operation screen generating signal for generating at least one of the first operation screen for displaying the attribute information common to the plural image output devices satisfying the designated condition and the second operation screen for displaying all the attribute information of the plural image output devices satisfying the designated condition on the basis of the attribute information of each of the plural image output devices, and transmits the operation screen generating signal to the transceiver, and the transceiver receives the operation screen generating signal through the network. The attribute information common to the plural image output devices is achieved through a logical product (AND) of the attributes of the plural image output devices, and all the attribute information items owned by the plural image output devices are achieved through a logical sum (OR) of the attributes of the plural image output devices. The image data are input from the image data input device, and at least one of the first operation screen for displaying the attribute information common to the plural image output devices satisfying the designated condition and the second operation screen for displaying all the attribute information of the plural image output devices satisfying the designated condition on the basis of the attribute information of each of the plural image output devices, which is generated on the basis of the operation screen generating signal, is displayed on the display input device.

The display input device is supplied with the information indicating the condition for the operation screen to be displayed, and also with the information indicating the image output device for outputting the image from the operation screen displayed and the information on the output format of the image to be output from the image output device designated. The information input from the display input device and the image data input from the image data input device are transmitted through the network from the transceiver to the image output managing device. The image output managing device transmits to the designated image output device the information on the output format of the image and the image data which are transmitted from the transceiver. The image output device outputs the image on the basis of the image data and information on the image output format transmitted through the network.

As described above, the operation screen common to the plural image output devices having different attributes is used, and also the result of the logical operation to the attributes of the plural image output devices is displayed on the operation screen concerned. Therefore, the output condition can be easily selected, and the operation screen can be efficiently operated. For example, in the case of the equal-shared output method or the multiple output method, the logical product (AND) of the attributes of the plural image output devices is displayed, and if an attribute is selected from the range of AND, it would be guaranteed that the same output result can be achieved from the plural image output devices. Further, the logical sum (OR) of the attributes of the plural image output devices may be displayed to show the overall selectable attribute range. The logical operation may be carried out every attribute item of the plural image output devices.

Particularly when all the attribute information items of the plural image output devices satisfying the designated condition are displayed on the operation screen, one image output device is selected from the plural image output devices on the basis of the information on the image output format input from the operation screen, so that a desired attribute can be selected from the overall selectable attribute range and also the most proper output result can be achieved.

Further, when the number of attribute information items to be displayed on the operation screen is equal to a predetermined value or more, attribution information items over the predetermined value can be displayed on one attribute item. An interface part for displaying this attribute item may be provided to display the attribute information items over the predetermined value in detail in accordance with an operation carried out on the interface part, whereby it is guaranteed that the overall selectable attribute range is displayed.

Further, in order to achieve the object, a fifth aspect of the present invention is a user interface device for selecting an image output device of a plurality of image output devices connected to a network, the user interface device comprising an operation screen displaying the image output devices for selection, which are connected to the network and available for image output, on the basis of attribute information of each of the image output devices.

A sixth aspect of the present invention is an image input device for use in an image output system, wherein the image output system includes a plurality of image output devices connected to a network and that output images on the basis of image data and output image format information, and an image output managing device connected to the network, which checks status of the image output devices, and transmits a signal for generating an operation screen on the basis of only attribute information of each one of the image output devices available for image output, the image input device comprising: an image data input device for inputting the image data; a display input device for displaying the operation screen, and inputting from the operation screen, information indicating image output devices for outputting images and image output format information for images to be output from the designated image output devices; and a transceiver connected to the network that transmits the information and image data input from the display input device through the network to the image output managing device and receives the signal for generating the operation screen through the network.

A seventh aspect of the present invention is an image input device for use in an image output system, wherein the image output system includes a plurality of image output devices connected to a network and that output images on the basis of image data and output image format information, and an image output managing device connected to the network that transmits a signal for generating an operation screen on the basis of attribute information of each of the image output devices available for image output, the image input device comprising: an image data input device for inputting the image data; a display input device for displaying the operation screen, and inputting from the operation screen, information indicating image output devices for outputting images and image output format information for images to be output from the designated image output devices; and a transceiver connected to the network that requests status checks during predetermined operation of the operation screen, and transmits the information and image data input from the display input device through the network to the image output managing device when image output devices available for image output are designated, and receives the signal for generating the operation screen through the network.

An eighth aspect of the present invention is an image output managing device for use in an image output system, the device comprising: a plurality of image output devices connected to a network that output images on the basis of image data and image output format information transmitted through the network; an image data input device for inputting the image data; a display input device for displaying in response to a signal, an operation screen and inputting from the operation screen, information to designate from which image output devices to output images and output format information for the images to be output from the designated image output devices; and a transceiver to the network, wherein the transceiver transmits image data and information input from the display and image data input devices through the network to the image output managing device, and the image output managing device checks the status of the image output devices, and transmits the signal for generating the operation screen on the basis of only the attribute information of each image output device that is available for image output, and transmits the image data and information to the designated image output devices.

A ninth aspect of the present invention is an image output managing device for use in an image output system, the device comprising: a plurality of image output devices connected to a network that output images on the basis of image data and image output format information transmitted through the network; an image data input device for inputting the image data; a display input device for displaying in response to a signal, an operation screen and inputting from the operation screen, information to designate from which image output devices to output images and output format information for the images to be output from the designated image output devices; and a transceiver connected to the network, wherein when image output devices available for image output are designated, the transceiver transmits on the basis of status of image output devices, image data and information input from the display and image data input devices through the network to the image output managing device, and the image output managing device transmits the signal for generating the operation screen on the basis of attribute information of each of the image output devices, requests status checks for designated image output devices during predetermined operation of the operation screen, and when image output devices available for image output are designated, transmits the image data and information to the designated image output devices.

According to a tenth aspect of the present invention, there is provided an image output system comprising: a plurality of image output devices connected to a network that output images on the basis of image data and image output format information transmitted through the network; an image data input device for inputting the image data; a display input device for displaying in response to a signal, an operation screen and inputting from the operation screen, information to designate from which image output devices to output images and output format information for the images to be output from the designated image output devices; and a transceiver and image output managing device connected to the network, wherein the transceiver transmits image data and information input from the display and image data input devices through the network to the image output managing device, and the image output managing device checks the status of the image output devices, and transmits the signal for generating the operation screen on the basis of only the attribute information of each image output device that is available for image output, and transmits the image data and information to the designated image output devices.

According to an eleventh aspect of the present invention, there is provided an image output system comprising: a plurality of image output devices connected to a network that output images on the basis of image data and image output format information transmitted through the network; an image data input device for inputting the image data; a display input device for displaying in response to a signal, an operation screen and inputting from the operation screen, information to designate from which image output devices to output images and output format information for the images to be output from the designated image output devices; and a transceiver and image output managing device connected to the network, wherein when an image output device available for image output is designated, the transceiver transmits image data and information input from the display and image data input devices through the network to the image output managing device, and the image output managing device requests status checks for a designated image output devices during predetermined operation of the operation screen, transmits the signal for generating the operation screen on the basis of attribute information of each image output device, and transmits the image data and information from the transceiver to the designated image output device.

The user interface device of the fifth aspect of the present invention displays the operation screen to select only output-capable image output devices on the basis of the attribute information of each of the plural image output devices connected to the network. Therefore, the attributes of output-incapable image output devices are not displayed before the operation screen is generated, and occurrence of some job in the output-incapable image output devices can be prevented.

In the sixth, eighth and tenth aspects of the present invention, the plural image output devices, the image output managing device, and the image input device including the image data input device, the display input device and the transceiver are connected to the network. The image output managing device checks the status of each of the plural image output devices, generates the signal to generate the operation screen on the basis of only the attribute information of each of the output-capable image output devices in the plural image output devices, and transmits the signal to the transceiver. The transceiver receives the signal to generate the operation screen through the network. The image data are input from the image data input device, and the operation screen generated on the basis of the signal to generate the operation screen is displayed on the display input device. The information to designate the image-outputting image output devices and the information on the output format of the image to be output from the designated image output devices are input from the displayed operation screen to the display input device. The information input from the display input device and the image data input from the image data input device are transmitted from the transceiver through the network to the image output managing device. The image output managing device transmits the information on the output format of the image and the image data transmitted from the transceiver to the designated image output devices. The image output devices output the image on the basis of the image data and the information on the output format of the image transmitted through the network.

According to the twelfth aspect of the present invention, there is provided an input control device for use in an image output system, wherein the image output system includes a plurality of image output devices connected to a network, the input control device comprising logic that accepts input of information for indicating an image output device for image output and image format information for the image to be output, and a partial reset instruction to return a part of the information input to an initial value, and only one of the information for indicating the image output device and the image format information is returned to an initial value when the partial reset instruction is accepted.

According to the twelfth aspect of the present invention, in order to output an image from an image output device(s), input of the information for indicating the image-outputting image output devices from the plural image output devices and the information on the output format of the image to be output from the designated image output devices is accepted in the instruction input means. At this time, when the partial reset instruction is accepted, the designation information of the image output devices serving as the output destinations input or the information of the output format of the image is left unchanged and only the information on the output format or only the designation information of the image output devices serving as the output destinations is returned t the initial value in the instruction input means. The image output devices may be physically designated with the names of the devices or the like or logically designated by the function or the like.

According to a thirteenth aspect of the present invention, there is provided an input control method for use in an image output system, wherein the image output system includes a plurality of image output devices connected to a network, the method comprising the steps of: accepting input of information for indicating an image output device for image output and image format information for the image to be output; accepting a partial reset instruction to return a part of the information input to an initial value; and when the partial reset instruction is accepted, returning only one of the information for indicating the image output device and the image format information to an initial value.

According to the thirteenth aspect of the present invention, in order to output an image from an image output device(s), input of the information to designate the image-outputting image output devices from the plural image output devices and the information on the output format of the image to be output from the designated image output devices is accepted. At this time, when the partial reset instruction is accepted, the designation information of the image output devices serving as the output destinations input or the information on the output format of the image is left unchanged, and only the information on the output format or only the designation information of the image output devices serving as the output destinations is returned to the initial value. The image output devices may be physically designated on the basis of the names of the devices or the like, or logically designated by utilizing the function or the like.

In the twelfth and thirteenth aspects of the present invention, when the operator erroneously sets any one of the designation information of an image output device(s) serving as an output destination and the information on the output format of the image, by inputting the partial reset instruction, correctly-set information can be left unchanged and only incorrectly-set information can be reset. Accordingly, the number of operator's operations can be reduced as compared with the prior art, and the operability can be enhanced.

According to a fourteenth aspect of the present invention, there is provided an input control device for use in an image output system, wherein the image output system includes a plurality of image output devices are connected to a network, the input control device comprising logic that accepts input of information for indicating an output method for an image, information for indicating an image output device in conformity with the designated output method, and output format information of an image to be output from the designated image output device, and a reset instruction to return a part of the information input to an initial value, and when the partial reset instruction is accepted, any one or only two of the information for indicating the output method, the information for indicating the image output device and the output format information are returned to initial values.

According to the fourteenth aspect of the present invention, in order to output an image from an image output device(s), the instruction input means accepts input of the information for indicating the output method of the image, for example, the information of indicating (physically or logically) an image-outputting image output device(s) from plural image output devices constituting the print system in conformity with the output method (for example, when the equal output method or multiple output method is designated, plural image output devices are designated as output destinations or the like), and the information on the output format of the image to be output from the designated image output device(s). At this time, when accepting the partial reset instruction, in the instruction input means, at least one of the information for indicating the output method of the input image, the information for indicating the image output device(s) serving as output destination(s) and the information on the output format of the image is left unchanged, and only the other information is returned to the initial value.

According to a fifteenth aspect of the present invention, there is provided an input control method for use in an image output system, wherein the image output system includes a plurality of image output devices connected to a network, the method comprising the steps of: accepting input of information for indicating an output method for an image, information for indicating an image output device in conformity with the designated output method, and image format information for the image to be output; accepting a reset instruction to return a part of the information input to an initial value; and when the partial reset instruction is accepted, returning any one or two of the information for indicating the output method, the information for indicating the image output device, and the image format information to initial values.

That is, in the fourteenth and fifteenth aspects of the present invention, when the operator erroneously sets at least any one of the information for indicating the output method of an image, the information for indicating an image output device(s) serving as an output destination(s) and the information on the output format of the image, the operator can leave the correctly-set information unchanged, and reset only the incorrectly-set information by operating the partial reset means. Therefore, the number of operations carried out by operator can be reduced as compared with the prior art, and the operability can be enhanced.

The above input control device may further accept an overall reset instruction to return all the information items thus input to initial values, and when the overall reset instruction is accepted, it may return all the input information items to the initial values.

The input control method as described above may further accept an overall reset instruction to return all the input information items to initial values, and when the overall reset instruction is accepted, it may return all the input information items to the initial values.

According to a sixteenth aspect of the present invention, there is provided an image output system comprising: a plurality of image output devices for outputting an image on the basis of image data and image output format information, and an image input device for inputting the image data, each of the plural image output devices and the image input device being connected to a network; a display input portion for displaying an operation screen and inputting information for indicating from the operation screen, an image output device for outputting the image and image output format information for an image to be output from the designated image output device; and a partial reset portion for returning to an initial value only one of the information for indicating the image output device and the image output format input from the display input portion upon operation thereof.

According to the sixteenth aspect of the present invention, by inputting the information from the display input means, an image output device(s) which output an image is selected and designated from the plural image output devices, and the information on the output format of the image to be output from the designated image output device(s) is set. At this time, if the partial reset means is operated, the designation information of the image output device(s) serving as the output destination(s) or the information on the output format of the image is left unchanged, and only the information on the output format or only the designation information of the image output device(s) serving as the output destination(s) is returned to the initial value. Each image output device may be physically designated by the name thereof or the like or logically designated by using the function or the like.

Accordingly, even when the operator erroneously sets at least any one of the designation information of the image output device serving as the output destination and the information on the output format of the image, the operator can leave the correctly-set information unchanged, and reset only the incorrectly-set information by operating the partial reset means. Therefore, the number of operations carried out by operator can be reduced as compared with the prior art, and the operability can be enhanced.

According to a seventeenth aspect of the present invention, there is provided an image output system comprising: a plurality of image output devices for outputting an image on the basis of image data and image output format information, and an image input device for inputting image data, each of which is connected to a network; a display input portion for displaying an operation screen and inputting from the operation screen, information for indicating an output method of the image information for indicating an image output device outputting the image in conformity with the output method thus designated and information on an output format of the image to be output from the designated image output device; and a partial reset portion for returning to an initial value or initial values any one or only two of the information for indicating the output method, the information for indicating the image output device and the image output format information input from the display input portion upon operation thereof.

According to the seventeenth aspect of the present invention, by the information input from the display input means, the output method of the image is designated, an image-outputting image output device(s) is (physically or logically) designated from plural image output devices constituting the print system in conformity with the output method (for example, when the equal output method or multiple output method is designated, plural image output devices are designated as output destinations or the like), and the information on the output format of the image to be output from the designated image output device(s) is set. At this time, when the partial reset means is operated, at least one of the information for indicating the output method (method) of the image, the information for indicating the image output device(s) serving as the output destination(s) and the information on the output format of the image is left unchanged, and only the other information items are returned to the initial values.

Accordingly, even when the operator erroneously sets at least any one of the designation information of the image output device serving as the output destination and the information on the output format of the image, the operator can leave the correctly-set information unchanged, and reset only the incorrectly-set information by operating the partial reset means. Therefore, the number of operations carried out by operator can be reduced as compared with the prior art, and the operability can be enhanced.

The image output system as described above may further include overall reset means for returning all the information items input from the display input means to predetermined initial values.

According to an eighteenth aspect of the presents invention, there is provided an image output system comprising:

a plurality of image output devices each of which is connected to a network, and outputs an image on the basis of image data and image output format information transmitted through the network; an image input device including image data input means for inputting the image data, display input means for displaying an operation screen and inputting from the operation screen for indicating an image output device to output an image, and image output format for the image partial reset portion for returning to an initial value any one of the information for indicating the image output device and the image output format information input from the display input portion; and a transmission portion that is connected to the network and transmits through the network the image data input from the image data input means and the information input from the display input means; and an image output managing device that is connected to the network, transmits the image data and the image output format transmitted from the transmission portion to the designated image output device.

According to the eighteenth aspect of the present invention, in the image input device, the image data are input by the image data input means, both the information for (physically or logically) indicating an image-outputting image output device(s) from the plural image output devices and the information on the output format of the image to be output from the designated image output device(s) are input by the display input means, and then the information thus input is transmitted to the image output managing device by the transmitting means. In the image output managing device, the image data and the information on the output format of the image thus transmitted are transmitted to the image output device(s) which are designated on the basis of the information for indicating the image output device(s).

Further, in the image input device, when the partial reset means is operated, the designation information of the image output device(s) serving as the output destination(s) or the information on the output format of the image is left unchanged, and only the information on the output format or only the designation information of the image output device(s) serving as the output destination(s) is returned to the initial value, whereby the operability can be enhanced.

According to a nineteenth aspect of the present invention, there is provided an image output system comprising: a plurality of image output devices each of which is connected to a network and outputs an image on the basis of image data and image output format information of an image transmitted through the network; an image input device including image data input portion for inputting image data, a display input portion for displaying an operation screen and inputting from the operation screen, information for indicating an output method of an image, information for indicating an image output device outputting the image in conformity with the designated output method and image output format information for the image to be output from the designated image output device, a partial reset portion for returning any one or only two of the information for indicating the output method, the information for indicating the image output device and the image output format information input from the display input portion to initial values upon operation thereof, and a transmission portion that is connected to the network, and transmits the image data input from the image data input portion and the information input from the display input portion; and an image output managing device that is connected to the network, and transmits the image data and the information on the output format of the image transmitted from the transmission portion to the designated image output device.

According to the nineteenth aspect of the present invention, in the image input device, the image data are input by the image data input means, the information for indicating the output method of the image, the information for (physically or logically) indicating the image-outputting image output devices from the plural image output devices constituting the print system in conformity with the output method concerned and the information on the output format of the image to be output from the image output devices thus designated are input by the display input means, and these information items are transmitted to the image output managing device by the transmitting means. In the image output managing device, the image data and the information on the output format of the image thus transmitted are transmitted to the image output devices that are designated on the basis of the information for indicating the image output devices.

In the image input device, when the partial reset means is operated, at least one of the information for indicating the output method of the image, the information for indicating the image output device(s) serving as the output destinations and the information on the output format of the image are left unchanged, and only the other information items are returned to the initial values, whereby the operability can be enhanced.

The image input device may further comprise overall reset means for returning all the information items input from the display input means to predetermined initial values upon operation.

According to a twentieth aspect of the present invention, there is provided an image input device for connection to an image output system through a network, wherein the image output system includes a plurality of image output devices connected to the network for outputting an image on the basis of image data and image output format information, thereby constituting an image output system, the image input device comprising: an image data input portion for inputting the image data; a display input portion for displaying an operation screen and inputting from the operation screen, information for indicating an image output device for outputting an image and image output format information for the image to be output from the designated image output device; and a partial reset portion for returning only one of the information for indicating the image output device and the image output format information input from the display input portion to an initial value.

According to the twentieth aspect of the present invention, in the image device, the image data are input by the image data input means, the image-outputting image output devices are (physically or logically) designated from the plural image output devices by inputting the information from the display input means, and the information on the output format of the image to be output from the image output device(s) thus designated is set. At this time, in the image input device, when the partial reset means is operated, the designation information of the image output device(s) serving as the output destination(s) or the image on the output format of the image are left unchanged, and only the information on the output format or only the designation information of the image output device(s) serving as the output destination(s) is returned to the initial value, whereby the operability can be enhanced.

According to a twenty first aspect of the present invention, there is provided an image input device for connection to an image output system through a network, wherein the image output system includes a plurality of image output devices connected to the network for outputting an image on the basis of image data and image output format information, thereby constituting an image output system, the image input device comprising: an image data input portion for inputting the image data; a display input portion for displaying an operation screen and inputting from the operation screen information for indicating an output method of an image, information for indicating an image output device outputting the image in conformity with the designated output method, image output format information for the image to be output from the designated image output device; and a partial reset portion for returning any one or only two of the information for indicating the output method, the information for indicating the image output device and the image output format information input from the display input means to initial values upon operation thereof.

According to the twenty first aspect of the present invention, in the image input device, the image data are input by the image data input means, the output method of the image is designated by the information input from the display input means, the image-outputting image output devices are (physically or logically) designated from the plural image output devices constituting the print system, and the information on the output format of the image to be output from the image output device(s) thus designated is set. At this time, in the image input device, when the partial reset means is operated, at least one of the information for indicating the output method of the image, the information for indicating the image output device(s) serving as the output destination(s) and the information on the output format of the image is left unchanged, and only the other information items are returned to the initial values, whereby the operability can be enhanced.

The image input device may further comprise overall reset means for returning al the information items input from the display input means to predetermined initial values upon operation.

According to a twenty second aspect of the present invention, there is provided a group registering method for image output devices in an image output system, wherein the image output system includes a plurality of image output devices connected to a network, with each image output device having a plurality of attributes, the method comprising: searching for image output devices having a designated attribute; and grouping the image output devices searched on the basis of information for group instruction and registration of the image output devices.

According to the twenty second aspect of the present invention, the image output devices having the designated attribute are searched from the plural image output devices having plural attributes, each of which is connected to the network, and the image output devices thus searched are grouped and registered on the basis of the information for instructing grouping. Accordingly, by merely indicating an attribute for grouping, image output devices having the attribute concerned are automatically searched, so that the image output devices having the same attribute can be grouped. That is, the image output devices having the same attribute can be simply and accurately selected and registered as a group.

The image output devices having the designated attribute may be searched on the basis of the pre-stored attribute information or detected attribute information of each of the plural image output devices.

According to a twenty third aspect of the present invention, there is provided an image output system comprising: a plurality of image output devices each of which is connected to a network and outputs an image on the basis of image data transmitted through the network; an image input device connected to the network, the image input device including a image data input portion for inputting the image data, a display input portion for inputting information for indicating a search condition for image output devices and information for instruction of selective grouping of image output devices satisfying the search condition, and transmitting/receiving portion for transmitting the image data input from the image data input portion and the information input from the display input portion and receives the attribute information of image output devices satisfying the search condition; and a managing device that is connected to the network searches the plurality of image output devices for those satisfying the search condition, and registers image output devices as a group according to the information for instruction of selective grouping.

According to a twenty fourth aspect of the present invention, there is provided an image input device for use in an image output system including a plurality of image output devices each of which is connected to a network and outputs an image on the basis of image data and an output format transmitted through the network, and a managing device that is connected to the network, searches the image output devices on the basis of attribute information of each of the image output devices for those satisfying a search condition, transmits the attribute information of the image output devices searched through the network and registers the image output devices on the basis of information for instruction of grouping, the image input device comprising: an image data input portion for inputting image data; a display input portion for inputting information for displaying a search condition for the image output devices and information for instruction of selective grouping of image output devices satisfying the search condition, and displaying the attribute information of the image output devices satisfying the search condition; and a transmitting/receiving portion that is connected to the network, transmits the image data input from the image data input means through the network, and the information input from the display input means and receives the attribute information of the image output devices satisfying the search condition.

According to a twenty fifth aspect of the present invention, there is provided a managing device for use in an image output system having a plurality of image output devices each of which is connected to a network and outputs an image on the basis of image data transmitted through the network, the managing device comprising logic for inputting information for indicating a search condition for the image output devices and information for instruction for selective grouping of image output devices satisfying the search condition, and further searching of image output devices satisfying the search condition on the basis of attribute information of each of the image output devices, and transmitting the attribute information of the image output devices thus further searched, and registering image output devices as a group on the basis of the information for instruction of selective grouping.

According to a twenty sixth aspect of the present invention, there is provided a group registering method for a plurality of image output devices connected to a network in an image output system, wherein the image output devices output images on the basis of image data, and the image output system includes an image input device for inputting the image data, and a display input device for inputting information for indicating a search condition for the image output devices and for inputting information for instruction of selective grouping of image output devices satisfying the search condition, and displaying attribute information of the image output devices, and a managing device for managing the attribute information of each of the plurality of image output devices, the method comprising the steps of: transmitting from the image input device to the managing device the information representing the search condition for the image output devices input from the display input device; searching for image output devices satisfying the search condition on the basis of each of the attribute information of the plurality of image output devices and transmitting the attribute information of the image output devices thus searched to the image input device in the managing device; displaying the attribute information of the image output devices satisfying the search condition on the display input device and transmitting to the managing device information for instruction of selective grouping of image output devices satisfying the search condition input to the image input device; and registering the image output devices as a group according to the information for instruction of selective grouping.

The image output system according to the twenty third aspect and the group registering method for the image output devices according to the twenty sixth aspect of the present invention will be described together with the image input device according to the twenty fourth aspect and the managing device according to the twenty fifth aspect of the present invention.

The image input device is equipped with the image data input means. When the image data are input from the image input means, the image data input from the transmitting/receiving means are transmitted through the network. In the image output device(s), the image is output on the basis of the image data. Further, the image input device is equipped with the information display means, and when information for indicating a search condition is input from the information display means, the information thus input is transmitted to the managing device by the transmitting/receiving means.

The managing device manages the attribute information of each of the plural image output devices connected to the network, and the image output devices satisfy the search condition are searched from the plural image output devices. The attribute information items of the image output devices thus searched, that is, the attribute information items of the image output devices satisfying the search condition are transmitted to the image input device.

The image input device displays the attribute information items of the image output devices satisfying the search condition on the image output device. When the information for instructing to selectively group the image output devices satisfying the search condition is input from the display input means, the information thus input is transmitted to the managing device by the transmitting/receiving means.

In the managing device, grouping-instructed image output devices of the image output devices satisfying the search condition are registered as a group.

Accordingly, when the attribute of image output devices which are required to be grouped are input as a search condition from the display input means, image output devices satisfying the search condition are automatically searched by the managing device, and the attribute information of the image output devices thus searched is displayed as a choice for group registration on the display input device. Therefore, by checking this display and selecting image output devices to be grouped, the image output devices having the same attribute can be grouped. That is, the image output devices having the same attribute can be simply and accurately selected and registered as a group.

According to a twenty seventh aspect of the present invention, there is provided an image input device for use in an image output system, wherein the image output system includes image output devices and an image output managing device that is connected to a network, separates slave jobs from a master job with the slave jobs transmitted through the network and mutually associated with one another, and transmits the slave jobs to a designated image output device, and each of image output device is connected to the network, and executes the slave jobs transmitted from the image output managing device through the network, the image input device comprising: an image data input device for inputting image data to execute as the slave jobs; a display input device for receiving information for indicating an image output device to execute the slave jobs, setting the output processing based on image data input from the image data input device as the master job while setting output processing from a designated output device as slave jobs derived from the master job, issuing the master job and the slave jobs while mutually associating the master job and the slave jobs, and displaying the master jobs and displaying a list of the slave jobs associated with the master job in accordance with the operation of the master job when a job status is checked; and a transmitter that is connected to the network, and transmits the information input from the display input device and the master job and the slave jobs to the image output managing device through the network.

In the twenty seventh aspect of the present invention, the plural image output devices, the image output managing device and the image input device comprising the image data input device, the display input device and the transmitter are connected to the network. When the image data to execute the slave jobs are input from the image data input device and the information for indicating the image output device(s) executing the slave jobs are input to the display input device, the output processing based on the image data input from the image data input device is set as the master job, and the output processing from the image output device(s) thus designated is set as the slave jobs derived from the master job, the master job and the slave jobs are issued while being mutually associated with one another, and the slave jobs associated with the master job are displayed as a list in accordance with the master job. The information input from the display input device, the master job and the slave jobs are transmitted to the image output managing device by the transmitter. The image output managing device separates the slave jobs from the master job and the slave jobs which are mutually associated with one another, and transmits the slave jobs to the designated image output device(s). The image output device(s) executes the slave jobs transmitted from the image output managing device. Accordingly, the output processing (job) based on the image data input is displayed on the common operation screen in association with the output processing (job) from the designated image output device(s), and the check of the job status can be easily performed.

According to a twenty eighth aspect of the present invention, there is provided an image input device for use in an image output system, wherein the image output system includes image output devices and an image output managing device that is connected to a network, separates slave jobs from a mutually-associated master job and slave jobs transmitted through the network and transmits the separated slave jobs to a designated image output device, and each image output device is connected to the network and executes the slave jobs transmitted from the image output managing device through the network, the image input device comprising: an image data input device for inputting image data for execution as the slave jobs; a display input device for receiving information to designate a slave job executing output device and a command for the master job and the slave jobs, setting the output processing based on the image data input from the image data input device as a master job while setting the output processing from the designated image output device as slave jobs derived from the master job, and issuing the master job and the slave jobs while associating the master job and the slave jobs; and a transmitter that is connected to the network and transmits the information input from the display input device and the master job and the slave jobs through the network to the image output managing device.

In the twenty eighth aspect of the present invention, the commands to the master job and the slave jobs are input from the display input device, and thus the operation of the jobs (start, stop, resume, change or cancel) can be easily performed. Further, the commands to the master job are made effective to the master job and the slave jobs, and the commands to the slave jobs are made effective to only the slave jobs, whereby the overall operation of the jobs containing the slave jobs can be performed by using the commands to the master job, and each slave job can be individually operated by the commands to the slave jobs. As the commands are used instructions to start, stop, resume, change or cancel the jobs.

In the image input device, the master job and the slave jobs maybe associated with the identification information for identifying an inputting person, whereby the master job and the slave jobs can be easily picked up from the image input device in accordance with the identification information.

An image output system according to a twenty ninth aspect of the present invention is directed to an application in which the image input device of the twenty seventh aspect is applied to the image output system, and there is provided an image output system comprising: an image output managing device that is connected to a network, separates slave jobs from mutually-associated master job and slave jobs transmitted through the network and transmits the slave jobs thus separated to a designated image output device; plural image output devices each of which is connected to the network and executes the slave jobs transmitted from the image output managing device through the network; an image data input device for inputting image data for executing the slave jobs; a display input device for receiving information to designate a slave job executing image output device, setting the output processing based on the image data input from the image data input device as a master job while setting the output processing from a designated image output device as slave jobs derived from the master job, issuing the master job and the slave jobs while mutually associating the master job and the slave jobs with one another, and displaying the master job and displaying as a list the slave jobs associated with the master job in accordance with the operation of the master job when a job status is checked; and a transmitter that is connected to the network and transmitting the information input from the display input device and the master job and the slave jobs through the network to the image output managing device.

An image output system according to a thirtieth aspect of the present invention is directed to an application in which the image input device of the twentieth is applied to the image output system, and there is provided An image output system comprising: an image output managing device that is connected to a network, separates slave jobs from mutually-associated master job and slave jobs transmitted through the network and transmits the slave jobs thus separated to a designated image output device; plural image output devices each of which is connected to the network and executes the slave jobs transmitted from the image output managing device through the network; an image data input device for inputting image data to execute the slave jobs; a display input device for receiving information to instruct a slave job executing image output device and commands for the master job and the slave jobs, setting as a master job the output processing based on the image data input from the image data input device while setting the output processing from a designated image output device as slave jobs derived from the master job, and issuing the master job and the slave jobs while mutually associating the master job and the slave jobs with one another; and a transmitter that is connected to the network and transmits the information input from the display input device and the master job and the slave jobs through the network to the image output managing device.

### BRIEF DESCRIPTION OF THE DRAWINGS

FIG. 1 is a block diagram showing the structure of a print system according to a first embodiment of the present invention;

FIG. 2 is a block diagram showing the structure of a scanner according to the first embodiment of the present invention;

FIG. 3 is a block diagram showing the structure of a printer according to the first embodiment of the present invention;

FIG. 4 is a block diagram showing the structure of a server according to the first embodiment of the present invention;

FIG. 5 is a flowchart showing a processing routine executed by the printer in the first embodiment of the present invention;

FIG. 6 is a flowchart showing a processing routine executed by the server in the first embodiment of the present invention;

FIG. 7 is a flowchart showing a processing routine executed by the scanner in the first embodiment of the present invention;

FIG. 8 is a diagram showing an initial screen displayed on a display panel when the scanner is started in the first embodiment of the present invention;

FIG. 9 is a diagram showing a menu screen for service selection in the first embodiment of the present invention;

FIG. 10 is a diagram showing an operation screen to designate an output method (mode)/storage destination in the first embodiment of the present invention;

FIG. 11 is a diagram showing an operation screen for printing in the first embodiment of the present invention;

FIG. 12 is a diagram showing an individual number-of-copies indicating screen for designating numbers of output copies for each of printers in the first embodiment of the present invention;

FIG. 13 is a flowchart showing a processing routine executed by a server in a second embodiment of the present invention;

FIG. 14 is a flowchart showing a processing routine executed by a scanner in the second embodiment of the present invention;

FIG. 15 is a flowchart showing a processing routine executed by a controller of a scanner in a third embodiment of the present invention;

FIG. 16 is a diagram showing an operation screen for printing (reset button is implemented as a soft button) in the third embodiment of the present invention;

FIG. 17 is a diagram showing a print operation screen when designation of an output method is altered in the third embodiment of the present invention;

FIG. 18 is a diagram showing changes due to pressing of a reset button of the print operation screen of FIG. 17, wherein A to C show the print operation screen before the reset button is pressed, after the reset button is pressed once and after the reset button is double-pressed, respectively;

FIG. 19 is a diagram showing another print operation screen (reset button is implemented as a hard button) in the third embodiment of the present invention and changes caused by pressing the reset button, wherein A to C show the print operation screen before the reset button is pressed, after the reset button is pressed once and after the reset button is double-pressed, respectively;

FIG. 20 is a diagram showing another print operation screen (output destination selecting screen/detailed setting screen switching display) in the third embodiment and variations due to press of the reset button, wherein A shows the output destination selecting screen, B shows the detailed setting screen before the reset button is pressed, C shows the print operation screen after the reset button is pressed once, and D shows the print operation screen after the reset button is double-pressed;

FIG. 21 is a flowchart showing a processing routine executed by a controller of a server in a fourth embodiment of the present invention;

FIG. 22 is a flowchart showing a processing routine executed by a controller of a scanner in the fourth embodiment of the present invention;

FIG. 23 is a flowchart showing a group registration processing routine (subroutine) executed by a controller of a server in the fourth embodiment of the present invention;

FIG. 24 is a flowchart showing a group registration setting processing routine executed by the controller of the scanner in the fourth embodiment of the present invention;

FIG. 25A is a diagram showing a search condition setting operation screen in the fourth embodiment of the present invention;

FIG. 25B is a diagram showing a registration information setting operation screen in the fourth embodiment of the present invention;

FIG. 26 is a diagram showing a print operation screen in the fourth embodiment of the present invention;

FIG. 27 is a diagram showing a master job status checking screen of a fifth embodiment of the present invention;

FIG. 28 is a diagram showing a slave job status checking screen of the fifth embodiment of the present invention;

FIG. 29 is a flowchart showing an interrupt processing routine executed by the server in the fifth embodiment of the present invention;

FIG. 30 is a flowchart showing an interrupt processing routine executed by the server in the fifth embodiment of the present invention;

FIG. 31 is a flowchart showing an interrupt processing routine executed by the printer in the fifth embodiment of the present invention;

FIG. 32 is a flowchart showing details of operation of a job in the fifth embodiment of the present invention; and

FIG. 33 is a diagram showing a job setting altering screen in the fifth embodiment of the present invention.

### DETAILED DESCRIPTION OF THE PREFERRED EMBODIMENTS

Preferred embodiments of the present invention will be described in detail with reference to the accompanying drawings. In the following embodiments, the same or common constituent elements are represented by the same reference numerals. Further, in the following embodiments, the description of the same or common parts is omitted, and only the differences will be described. However, the present invention is not limited to the following embodiments, and it will be clear to persons skilled in the art how to combine the contents of the respective embodiments with one another without departing from the subject matter of the present invention.

(First Embodiment)

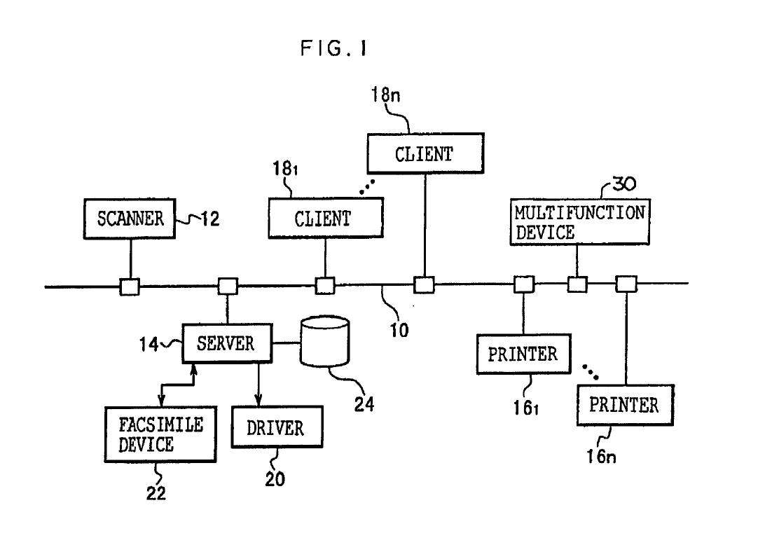

As shown in FIG. 1, a print system according to a first embodiment of the present invention is constructed by connecting a scanner 12 serving as an image data input device for inputting image data, a server 14, printers 16₁, 16₂, . . . , 16ₙ serving as plural image output devices and plural clients 18₁, 18₂, . . . 18ₙ to a network 10 comprising the Internet, a LAN or the like. The image data is represented in TIFF (Tagged Image File Format) format. Further, a multifunction device 30 having a printing function, a scanner function and a facsimile function is connected to the network 10.

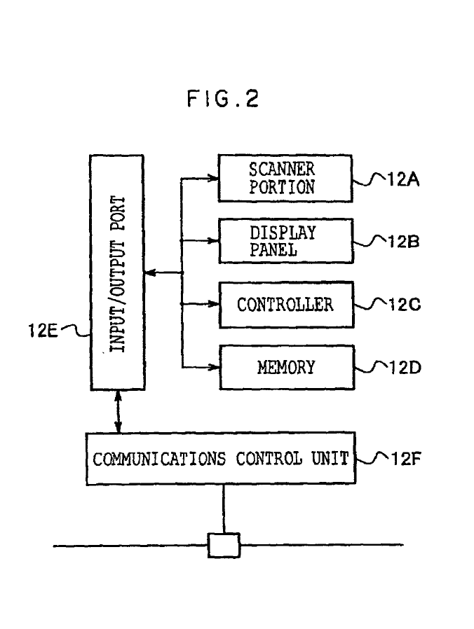

As shown in FIG. 2, the scanner 12 is equipped with a scanner portion 12A having a CCD for reading an image recorded on an original, a display panel 12B (or touch panel) functioning as a user interface for displaying a print operation screen with plural icons and for inputting data on print format (output format) of a printer, etc. by touching an icon displayed on the print operation screen, a controller 12C for controlling the overall scanner, a memory 12D for storing image data read by the scanner portion 12A, etc., and an input/output port 12E for inputting/outputting data. The scanner portion 12A, the display panel 12B, the controller 12C, the memory 12D and the input/output port 12E are mutually connected to one another through a bus. The input/output port 12E is connected to the network 10 through a communication control unit 12F for carrying out communications through the network with external equipment connected to the network.

The user interface for inputting data from the print operation screen is divided into a user interface part, which is screen information elements such as icons, buttons, a scroll bar, frames, etc., and attribute information of printers 16 represented by text data. The user interface part is stored in the memory 12D of the scanner, and the attribute information of the printers 16 is stored in the server 14, as described later. The screen information may be generated by HTML (Hypertext Markup Language).

As described above, the user interface is divided into the user interface part and the attribute information, and these are separately stored in the scanner 12 and the server 14. Therefore, when data constituting the user interface is transmitted from the server 14 to the scanner 12, the data amount transmitted from the server 14 to the scanner 12 is reduced, whereby the user interface can be quickly displayed on the display panel 12B. Programs of processing routines, described later, are also stored in the memory 12D.

All the information for the user interface to display the print operation screen is generated in the server 14 and transmitted to the controller 12C of the scanner 12 without being separately stored.

In place of the scanner 12, electronic image data recorded in a storage medium such as FDD, a CD-ROM or the like may be read and input. Further, image data may be input from a facsimile device or a database by using a personal computer, or image data may be input by using mail software installed in a personal computer.

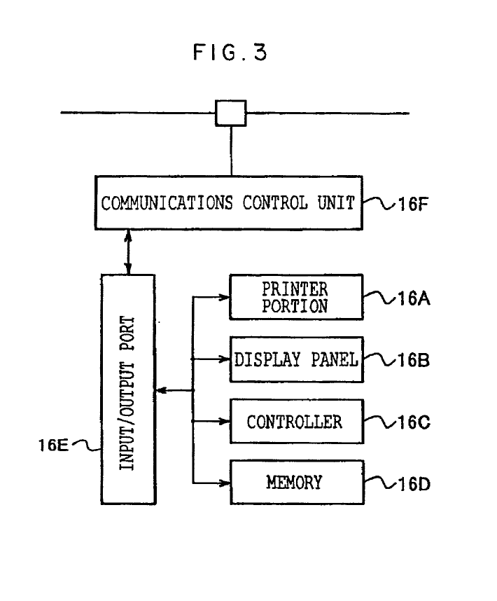

The printers 16₁, 16₂, . . . , 16ₙ have substantially the same structure, and are different only in attributes. Therefore, only one printer will be described, with reference to FIG. 3, and description of the other printers is omitted. In the following description, the subscripts of reference numerals are omitted if the respective printers are described without particularly discriminating, and each printer is referred to as “printer 16”.

As shown in FIG. 3, the printer 16 is equipped with a printer portion 16A for recording an electrostatic latent image on a photosensitive member, developing the latent image thus formed with monochromatic toner or color toner and transferring the developed image (visible image) onto a recording sheet serving as a recording medium, a display panel 16B for displaying an operation screen so that the printer 16 can be operated by touching an icon on the operation screen, a controller 16C for controlling the overall printer 16, a memory 16D for storing received image data, output format data, etc. and for storing programs of processing routines, described later, etc. in advance, and an input/output port 16E for inputting/outputting data. The printer portion 16A, the display panel 16B, the controller 16C, the memory 16D and the input/output port 16E are connected to one another through a bus. The input/output port 16E is connected to a network 10 through a communication control unit 16F for carrying out communications through the network 10 with equipment that is connected to the network 10.

The server 14 is connected to a write-capable driver 20 for reading and inputting data recorded in an external storage device such as a floppy disk, CD-ROM, CD-RW or the like, a facsimile device 22, and a database 24 for storing attribute information, etc. of all the printers 16 connected to the network.

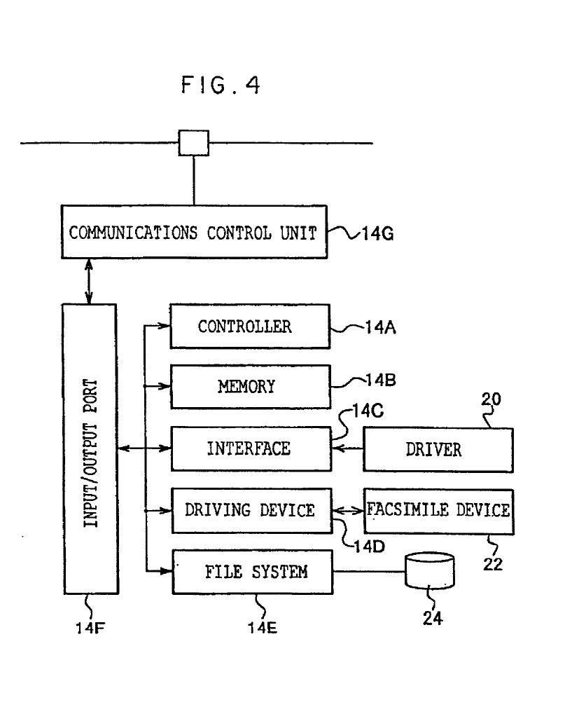

As shown in FIG. 4, the server 14 is equipped with: a controller 14A for controlling the overall server; a memory 14B in which received data is stored and in which a mailer for transmitting/receiving e-mails, a program for controlling transmission/reception of the facsimile device, and programs of processing routines, etc. are stored in advance; an interface 14C connected to the driver 20 having a CD-ROM writer or the like; a driving device 14D for driving the facsimile device 22; a file system 14E connected to the database 24; and an input/output port 14F for inputting/outputting data. The controller 14A, the memory 14B, the interface 14C, the driving device 14D, the file system 14E and the input/output port 14F are mutually connected to one another. The input/output port 14E is connected to the network 10 through a communication control unit 14G for carrying out communications through the network 10 with equipment connected to the network 10.

Further, the database 24 maybe connected to the database server connected to the network separately from the server 14.

Each of the clients 18₁, 18₂, . . . , 18ₙ comprises a personal computer equipped with a communication control unit for carrying out communications through the network with equipment connected to the network.

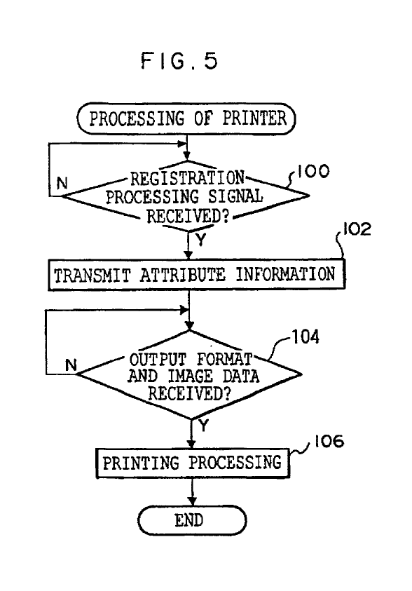

Next, the processing routine executed by each controller of the scanner, the server and the printer of an embodiment of the present invention will be described with reference to FIGS. 5 to 7. These processing routines are divided into attribute information registration processing, operation screen display processing, print instruction processing and print processing, and each processing will be separately described below.

[Attribute Information Registration Processing]

The attribute information registration processing is a processing for registering the attribute information of a printer 16 connected to the network into the database connected to the server 14.

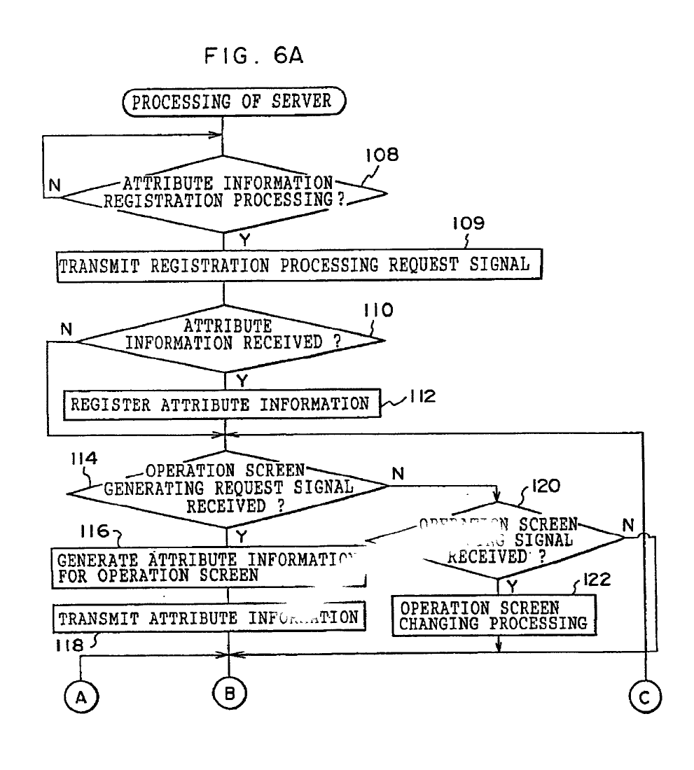

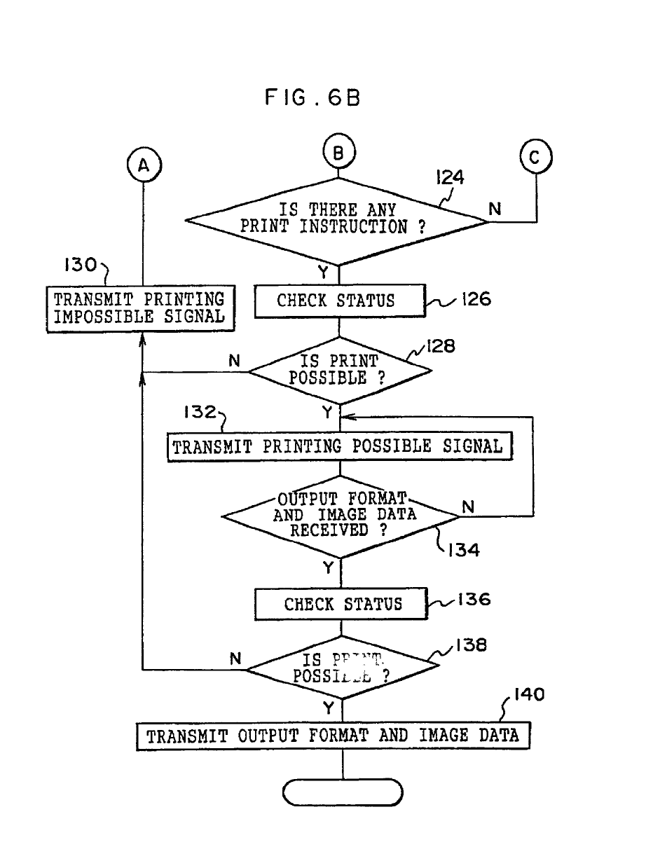

When the printer 16 is connected to the network 10, management tool software provided at the server 14 is operated through the network from an operation panel (not shown) provided at the server 14 or at a client 18 connected to the server 14 to carry out the attribute information registration processing for registering the attribute information of the printer 16 in the server 14. That is, if it is judged on the basis of an instruction to the management tool software in the server 14 in step 108 shown in FIG. 6 that there is a request for attribute information registration processing, a registration processing request signal for requesting registration processing of the printer attribute information is transmitted from the server 14 to the printer 16 in step 109.

At the printer 16, it is judged in step 100 of FIG. 5 whether a registration processing request signal has been received or not. If it is judged that the registration processing request signal has been received, the attribute information of the printer 16 is transmitted from the printer 16 to the server 14 in step 102.

The server 14 judges in step 110 whether the attribute information transmitted from the printer 16 has been received or not. When it is judged that the attribute information has been received, the server 14 controls the file system 14E in step 112 to register the attribute information of the printer 16 into the database 24.

The processing may be modified such that when the printer 16 is connected to the network 10, the attribute information is automatically transmitted from the printer 16 to the server 14 and the attribute information is automatically registered in the database 24, or the processing may be modified such that the attribute information of the printer 16 is detected by the server 14 and the attribute information thus detected is registered in the database. Further, the attribute information of the printer 16 may be registered in the server 14 by operating the display panel 16B provided at dot the printer 16. Accordingly, attribute information for all the printers 16 connected to the network 10 is registered in the database 24 connected to the server 14.

The attribute information of the printer 16 contains information indicating whether the printer is suitable for black-and-white (monochromatic) printing or color printing, information indicating whether the printer has a double-sided printing function, information indicating whether the printer has a finisher (a stapling function, a punching function or the like), information indicating whether the resolution is high resolution or low resolution, information indicating printable sheet size, information indicating the font types equipped to each printer, information on output formats of inherent color characteristic information, such as color maps, color adjustment information, etc. in the case of a color printer, etc., information on a setup location of each printer (floor, department, etc. when the printers are disposed in one building, or departments, etc. when the printers are disposed in different buildings), network setting information such as IP addresses, etc., and printer identifying information such as a printer name or the like. All the information on the output format/output conditions of the printers 16 is registered as attribute information in the database.

[Operation Screen Display Processing]

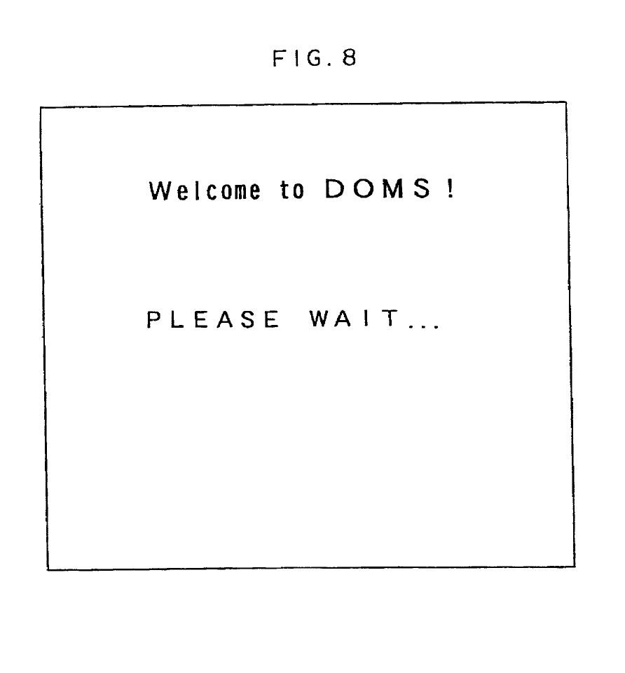

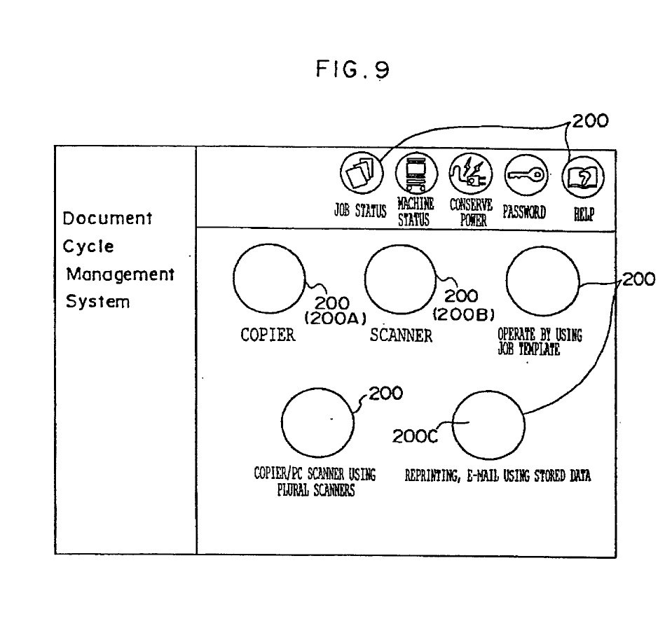

When the scanner 12 is started, an initial screen shown in FIG. 8 is displayed first on the display panel 12B of the scanner 12, and then a menu screen for service selection shown in FIG. 9 is displayed. Service selection buttons 200 represented by icons are displayed on the menu screen as shown in FIG. 9. If a button 200A is clicked, a copy (print) service is selected, and if a button 200B is clicked, a scanner service is selected.

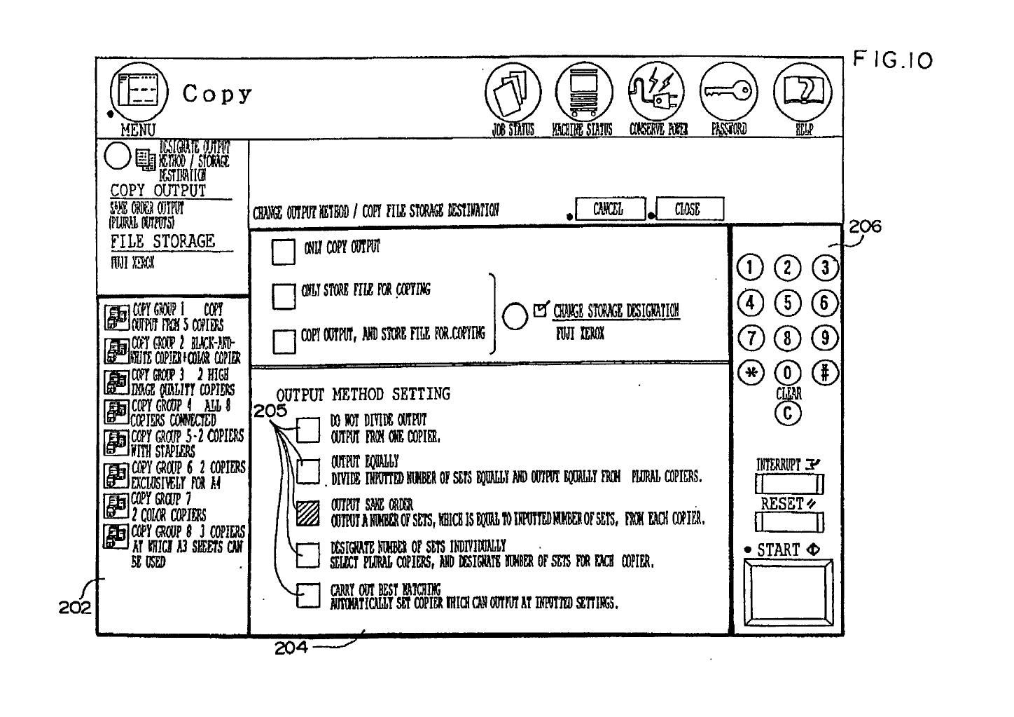

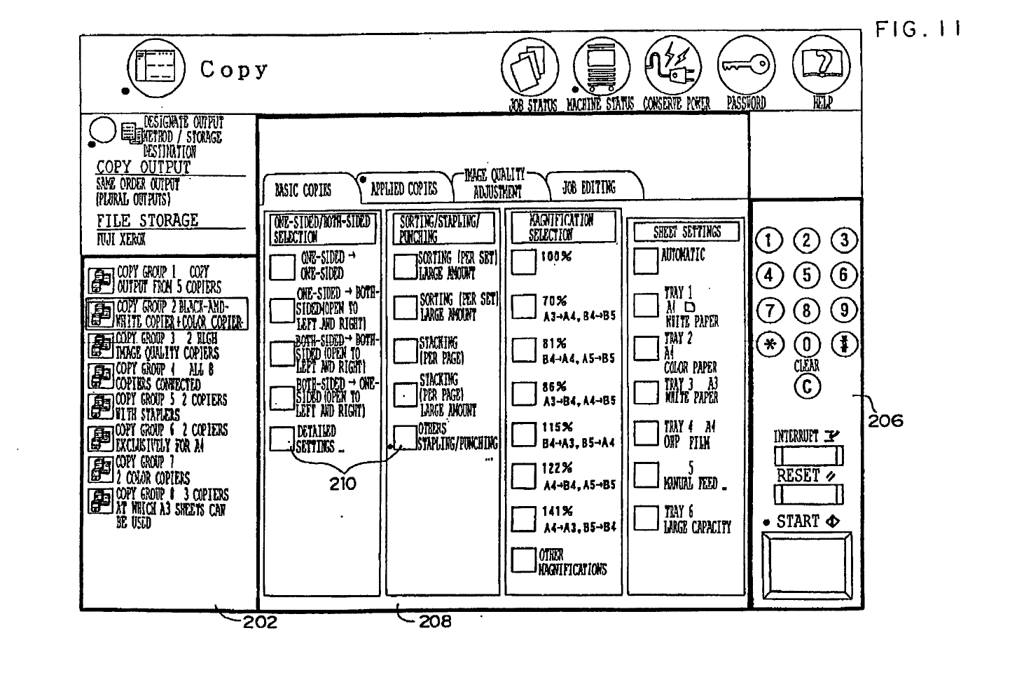

When, from the menu screen of FIG. 9 displayed on the display panel 12B of the scanner 12, the button 200A is pressed by an operator to select the copy service from the menu, the operation screen for indicating an output method/storage destination shown in FIG. 10 is displayed. The operation screen includes a group display portion 202 for displaying the printers 16 connected to the network 10 when the printers 16 have been classified into pre-registered groups by operator operations, a setting portion 204 for setting the output method, etc., and a ten key portion 206. Selection buttons 205 for the output method, etc., represented with icons, are displayed on the setting portion 204.

The following choices are provided for the output method: a “do not divide output” method, in which the job is output from one printer and is not divided; an “output equally” method, in which the input number of copies is divided so that output numbers of copies are equal among plural printers, and then the job is output to the plural printers; a “multiple output” method, in which the same number of copies as the input number is output from each printer; a “designate numbers of sets individually” method, in which plural printers are designated, and the number of copies is designated for each printer; and a “best matching” method, in which output conditions are set and then the printers optimum to the designated conditions are selected for output. By clicking one of the selection buttons 205, any one of the output methods can be selected. The operation screen shown in FIG. 10 designates a state in which the “multiple output” method, in which the same number of copies as the input number are output from each printer, is selected as the output method.

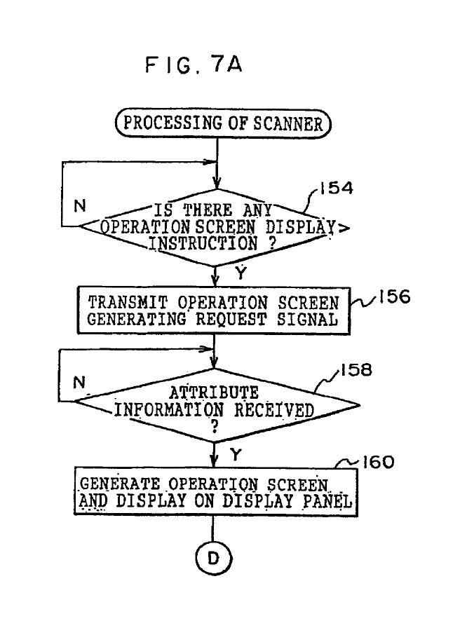

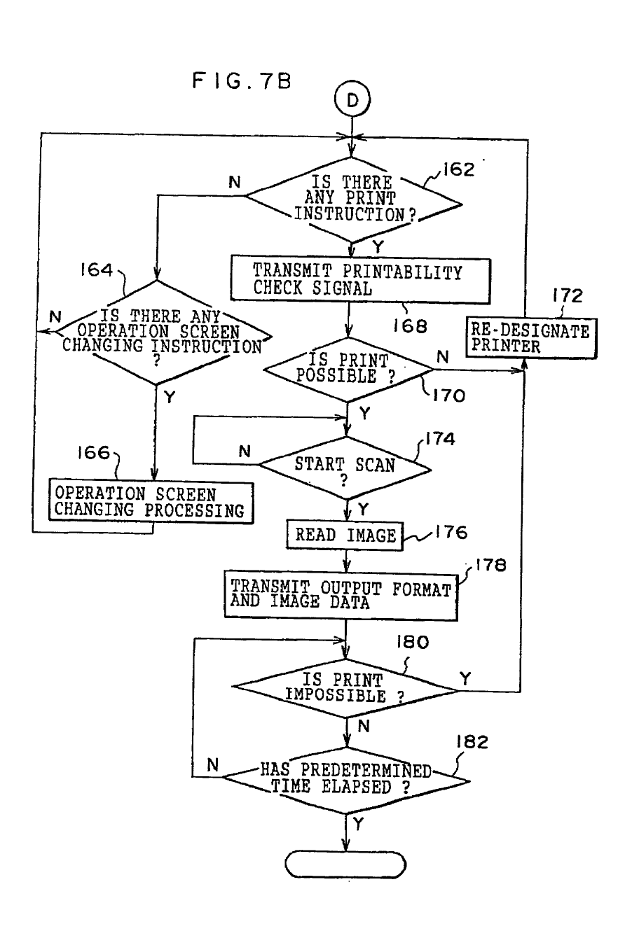

When one of the groups of the printers 16 displayed on the group display portion 202 of the operation screen is selected by the operator, it is judged in step 154 of FIG. 7 that there is a print operation screen display instruction, and an operation screen generating request signal to generate the print operation screen is transmitted from the scanner 12 to the server 14 in step 156. Further, information indicating that a group of the printers 16 has been selected may be transmitted alone from the scanner 12 to the server 14.

For designation of the printers 16 a method of designating one printer 16 may be adopted, or a method of designating one group, to have printer 16 belonging to the group designated output prints simultaneously. For example, a printer 16 belonging to a desired group can be selected by operating any one of group buttons 212 displayed with icons on the group display portion 202 .

In the server 14, it is judged in step 114 of FIG. 6 that the operation screen generating request signal transmitted from the scanner 12 has been received, the status of the printer 16 connected to the network 10 is checked in step 116, the attribute information to generate the print operation screen of the printer 16 designated is generated on the basis of the operation screen generating request signal, and the registered attribute information of the printer 16 and the attribute information generated in the scanner 12 are transmitted in step 118.

The transmitted operation screen generating request signal may be a signal for displaying all the attribute information of the printers 16 connected to the network 10, a signal for displaying only the attribute information of printers 16 having a color print function, of a signal for displaying only the attribute information of printers 16 of a group that is designated in advance.

At this time, if, on the basis of the status check of the designated printers 16, it is judged that there is a printer in a down state due to an error, such as being switched off, a paper jam, no paper stock in a tray or the like, the server 14 generates the attribute information to generate the print operation screen such that the attribute information of the printer 16 that is in the down state is not displayed. At this time, with respect to the down printer 16, information for display on the print operation screen to show error information indicating that the printer 16 is down may be generated.

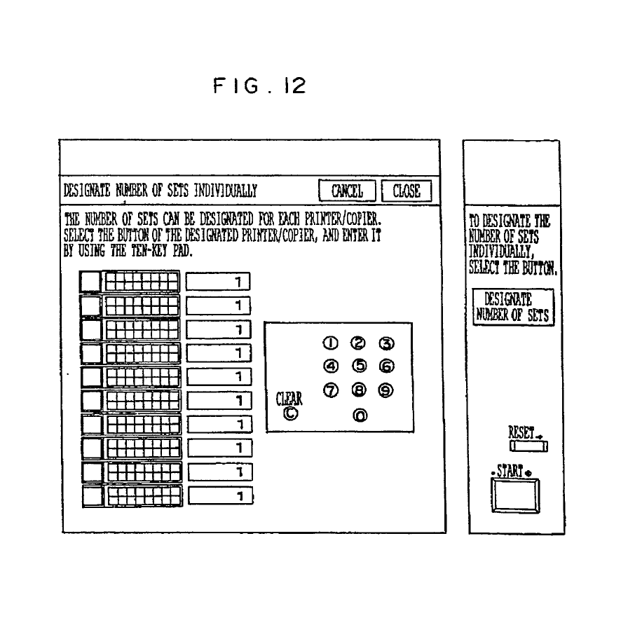

The attribute information is transmitted from the server 14 to the scanner 12. When it is judged in step 158 of FIG. 7 that the attribute information from the server 14 has been received, the scanner 12 combines the received attribute information to generate the print operation screen, represented by text data, with the user interface part indicating image information of buttons, etc. stored in the memory 12D to thereby generate the print operation screen, as shown in FIG. 11, and displays the print operation screen thus generated on the display panel 12B as the user interface in step 160.

The print operation screen is designed to include the group display portion 202 described above, a parameter setting portion 208 for setting sheet size and output parameters indicating the image data output formats such as magnification/reduction rate, etc., and the ten key portion 206 described above. Parameter selection buttons 210 splayed with icons are displayed in the parameter setting portion 208.

When the operator operates the print operation screen thus displayed to instruct a screen change of the print operation screen, the processing goes from step 162 of FIG. 7 to steps 164 and 166, and also goes from step 114 of FIG. 6 to steps 120 and 122 to carry out the operation screen changing processing. In the operation screen changing processing, as described in steps 156 to 160 of FIG. 7 and steps 114 to 118 of FIG. 6, a new operation screen generating request signal is transmitted to the server 14 in accordance with the operation of the display panel 12B of the scanner 12, and the attribute information to generate a new print operation screen is generated and transmitted by the server 14. Thus, the display of the print operation screen is changed in accordance with operations at the print operation screen of the display panel 12B of the scanner 12.

The operation screen changing processing will now be described in more detail.

When a group of the printers 16 displayed on the group display portion 202 of the print operation screen is selected by operating the print operation screen shown, a printer 16 belonging to the group is designated and an operation screen generating request signal, to set an output instruction to the printer belonging to the group thus designated, is transmitted. A logical product (AND) of the attribute information of the printers 16 belonging to the group is computed in the server 14, and common attribute information in each group is selected and transmitted to the scanner 12, whereby a print operation screen for displaying the group of the printers 16 and the common attribute information of the group is newly generated and displayed.

When plural printers 16 are registered as a group, the operator selects attribute information representing a function to be grouped, and transmits an operation screen generating request signal for displaying the printers 16 that have this attribute to the server 14. At this time, all the printers 16 that have the selected attribute are displayed, and the operator can perform grouping by selecting from the screen the printers 16 that the operator wants to group, and sending a grouping instruction to the server 14.

If the “do not divide output” button is selected by an operator for the output method on the screen shown in FIG. 10, to output one job without dividing the job, and one of the groups of the printers 16 displayed on the group display portion 202 has been selected, a list of the printers 16 belonging to the selected group (not shown) is displayed. Alternatively, a list of single printers 16 which have not been grouped (not shown) may be displayed on the group display portion 202. When an individual printer 16 is selected from the printer list, the attributes information of the selected printer 16 is selected in the server 14 and transmitted to the scanner 12, and the print operation screen for displaying the attribute information of the selected printer 16 is generated and displayed on the display panel 12B of the scanner 12.

If the operator selects, as the output method, the “best matching” method, in which output printer attribute information, that is, an output condition, is designated to select the printers 16 optimum to the conditions, a logical sum (OR) of attribute information of the printers 16 belonging to a group selected as output destinations is computed in the server 14, attribute information of the printers 16 is transmitted to the scanner 12 on the basis of the computation results, and the scanner 12 generates the print operation screen and displays it on the display panel 12B. On this screen, the operator can see a list of all the attributes which the operator can select. The logical operation on the attribute information may be carried out for every attribute item of the printers belonging to the group.

In the case where best matching output is carried out, the thus computed logical sum of the attribute information of the printers 16 is displayed on the display panel 12B of the scanner 12. In this case, if the number of attributes found by the logical sum is equal to a predetermined value or more, an icon that collectively displays all the attributes information over the predetermined value is provided(for example, a square icon at one side of which “others” is written) so that attribute information items beyond the predetermined value can be displayed in detail by clicking this icon or carrying out a pull-down operation.

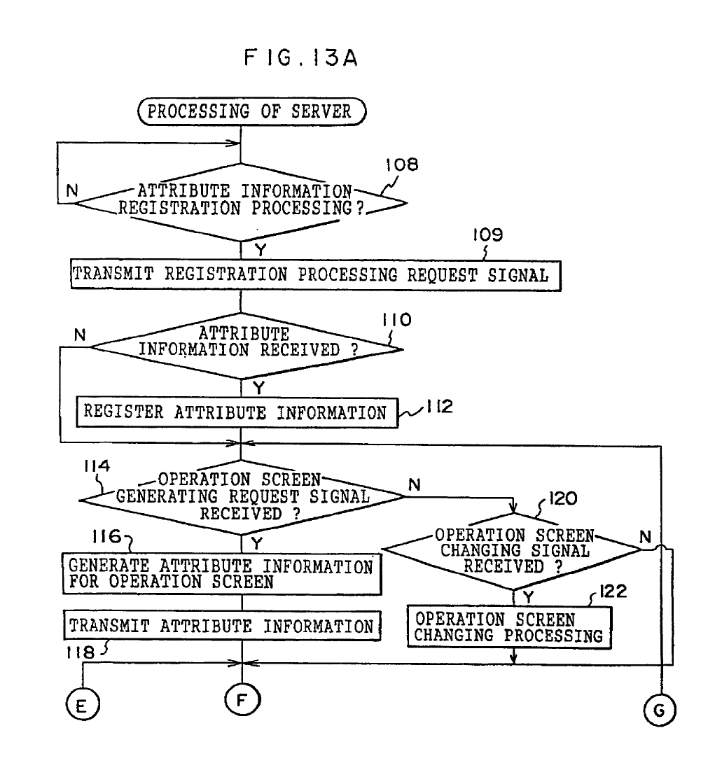

If the operator selects the “designate number of sets individually” method as the output method and a group of the printers 16 displayed on the group display portion 202 has been selected, an individual numbers of sets screen, shown in FIG. 12, for displaying the number of copies for each printer 16 belonging to the selected group is displayed. The operator can set the output number of copies for each printer from the individual numbers of sets screen. The print operation screen is displayed for every printer 16 that carries out the output operation.

If the “output equally” method is selected as the output method and a group of the printers 16 displayed on the group display portion 202 has been designated, the operation screen generating request signal for grouping is transmitted by the scanner 12. In the server 14, a logical product (AND) of the attribute information of the printers 16 belonging to the group is computed, and common attribute information of the group is selected and transmitted to the scanner 12. Accordingly, the print operation screen for displaying the group of the printer 16 and common attribute information of the group is generated and displayed. In the cases of the output equally method and the multiple output method, consistent output results are guaranteed by displaying the common attribute information.

[Print Instruction Processing]

The operator checks the attribute information of the printers 16 from the print operation screen shown in FIG. 11, sets output parameters indicating the sheet size, the image data output formats, such as magnification rate, etc. from the print operation screen, and then gives a print instruction.

When the operator has designated the printer(s) 16 to carry out the output operation, set the output parameters indicating the image data output formats and given the print instruction, it is judged in step 162 of FIG. 7 that a print designation has been made, and in step 168 a printability check signal for checking whether or not the designated printer(s) 16 can perform the print operation is transmitted to the server.

When the printability check signal is transmitted from the scanner 12 to the server 14 and it is judged in step 124 of FIG. 6 that the printability check signal has been received (the print instruction has been given), the status of the printer 16 designated in step 126 is checked, if the printability is judged from this status in step 128, the printing possible signal is transmitted to the scanner 12 in step 132. On the other hand, if it is judged in step 128 that the print is impossible, a printing impossible signal is transmitted to the scanner 12 in step 130.

It is judged in step 170 of FIG. 7 in the scanner 12 whether or not the printing possible signal has been received. If it is judged that the printing possible signal has been received, it is judged in the next step 174 whether image reading (start scan) has been instructed by an operator's press of a start button or the like. If it is judged in step 174 that the image reading instruction has been given, the scanner portion 12A is controlled in step 176 to read an image recorded on a mounted original in one operation, that is, a series of image data is read out as common image data, and stored as electronic image data in the memory 12D of the scanner. The output formats input from the operation screen and the image data read out from the scanner portion 12A are transmitted to the server 14 in step 178.

If the printing impossible signal is input in step 170, the operator is instructed to re-designate the printer(s) 16 in step 172. When the operator has re-designate the printer(s) 16 to carry out the output operation, by operating the display panel 12B, the processing goes from step 162 to step 168 as described above to transmit to the server 14 the printability check signal to check whether the print is possible or not. When the printing possible signal is received in step 170 and it is judged in step 174 that the image reading instruction has been given, the image data recorded on the original is read out in step 176, and the output format and the image data are transmitted to the server 14 in step 178.

As described above, as the manner of designating the printer(s) 16, one printer 16 may be designated, or a group may be designated to simultaneously output prints from the respective printers 16 belonging to the designated group.

When the grouping is carried out, as mentioned above, plural printers 16 having different functions as attributes may be preset as belonging to the same group so that prints are output from a printer 16 having a color output function and a printer 16 having a monochromatic output function on the basis of the same image data. In this case, if the output method is set such that one copy (print) is output from the printer 16 having the color output function and the rest number of the copies (prints) are output from the printer 16 having the monochromatic output function, cost can be reduced to a value less than in the case where all the copies (prints) are output in color.

Further, output numbers of copies (prints) may be indicted in accordance with sizes (for example, one copy at A4, all other copies at B4), output numbers of copies may be designated in accordance with recording sides (for example, one double-sided copy, the rest as one-sided copies), and output numbers of copies may be designated in accordance with the use or otherwise presence of a finisher (for example, one stapled copy, the rest as non-stapled copies).

Further, if it is instructed that one job is to be executed in plural printers 16, a job of each printer 16 is independently located in a lower layer of one job, and the upper layer job and all the lower layer jobs are executed together by control of the upper layer job (start, stop, resume, alter, delete and the like) . Further, each of the lower jobs may be independently executed by independent operations.

[Print Processing]

If it is judged in step 134 of FIG. 6 that the output format and the image data from the scanner 12 have been received in the server 14, the status of the printer(s) 16 designated to execute the job is checked in step 136, and it is recognized on the basis of the checked status in step 138 whether the print can be performed. If any error occurs in the designated printer(s) 16 and thus the print is impossible, the printing impossible signal is transmitted to the scanner 12 in step 130. Accordingly, in the scanner 12, it is judged in step 180 that the printing impossible signal has been received after the output format and the image data were transmitted, and in step 172 the operator is prompted to re-designate the printer(s) 16 on the operation screen. When the operator operates the display panel 12B to re-designate the printer(s) 16 that will carry out the output operation, when the printing possible signal is received and the start of the scan is instructed, an image is read out and the output format and the image data thereof are transmitted to the server 14 again. The processing returns to step 180 to repetitively judge whether the printing impossible signal has been received or not until it is judged in step 182 a predetermined time elapses.

Even if the printer 16 is re-designated after the output format and the image data are transmitted from the scanner 12 to the server 14, it is unnecessary to transmit the output format and the image data to the server 14 again because it is usual that the output format and the image data are not changed. Therefore, the output format and the image data which have been already transmitted to the server 14 may be used as is. If it is necessary to change the output format because of the re-designation of the printer 16, the output format alone may be transmitted to update the output format in the server 14.

When if it is judged in step 138 that the print will be possible, in step 140, an image data output format signal indicating the sheet size, the number of copies, etc. and the image data input from the scanner 12 are transmitted from the server 14 through the network 10 to the printer(s) 16 designated to carry out the print operation. When it is judged in step 104 of FIG. 5 that the output format and the image data transmitted from the server 14 have been received, in step 106 the printer 16 forms an image based on the image data on a recording sheet according to the output format designated, and outputs the recording sheet having the image recorded thereon.

As described above, according to the print system of this embodiment, the attribute information of the printers connected to the network is registered in the database of the server, so that the attribute information of the printers connected to the network can be accepted from the scanner of the server. The attribute information of the printers connected to the network may be accepted from clients other than the scanner.

Further, the operation screen having plural icons is displayed on the scanner, and the display panel functioning as the user interface for inputting the data on the print format, etc. of the printer by touching the icons thus displayed is provided. Therefore, when image data are input from the scanner, by the operator's designations on the operation screen displayed on the display panel, processing from an original reading step to a printing step can be automatically performed merely by setting the output parameters and then pressing the start button, as with a usual copying machine.

Still further, the attribute information of the printers connected to the network is registered in the database of the server, so that the attribute information of the printers connected to the network can be accepted from the scanner. Likewise, the attribute information of the printers connected to the network can be accepted from clients other than the scanner.

In the server, an operation screen generating request signal, for displaying the attribute information of all or some of the printers connected to the network, and text data for generating an operation screen on the basis of the attribute information of the printers connected to the network are generated and transmitted to the scanner. In the scanner, the operation screen is generated on the basis of the text data, etc. thus transmitted, and the operation screen thus generated is displayed on the display panel as a user interface. Therefore, the same operation screen can be displayed for even plural printers having different attributes, and the operation screen can be efficiently operated.

Particularly in the case of the output equally method and the multiple output method, it is guaranteed that the same output result can be achieved from plural printers by displaying the logical product of the attributes of the plural printers and selecting an attribute in the range of the logical product. Further, by displaying the logical sum of the attributes of the plural printers, the overall range of selectable attributes can be shown, and thus an optimum printer can be easily selected.

According to the above-described embodiment, in the scanner, the operation screen is generated on the basis of the transmitted text data, etc., and the operation screen thus generated is displayed as the user interface on the display panel. However, the user interface may be provided to any client or multifunction device to operate from the client or multifunction device side. For example, when a copying machine is connected to the print system of this embodiment, the copying machine usually operates as a standalone copying machine, but when “network copy method” is set, the multifunction device concerned operates as a user interface device, an image input device or an image output device.

Normally, the copying machine operates as a standalone copying machine and a user interface screen inherent to the copying machine is displayed on the display panel. However, when a shift to “network copy method” is instructed, the multifunction device transmits a request for information to generate a user interface screen to the server connected through the network, and displays, on the basis of information transmitted from the server, a user interface screen on which setting/designation of output formats to other equipment connected to the display panel of the copying machine through the network can be performed. If an operator selects printer(s) as output destination(s) and sets the output formats from this screen, and then instructs the start of network copying, an image reader of the copying machine reads an original, and the image thus read out and the information on the output destination printer(s) and the output formats are transmitted to the server to perform the print operation.

In this embodiment, the processing from the original reading step to the printing step is automatically carried out by first setting the output parameters and then pressing the start button, as on a normal copying machine. However, as described below, images may be read out and accumulated by a scanning service and then re-print instructions may be given so that the images thus accumulated are printed.

When images recorded on originals are to be accumulated, a “scanner” button 200B is pressed on the menu screen shown in FIG. 9 to select the scanning service, an original is set at the scanner portion 12A and then the start button is pressed, whereby it is judged that an image reading instruction has been given and the scanner portion 12A is controlled to read an image recorded on the original. The image data thus read is stored in the memory 12D of the scanner as electronic image data. In this case, it is preferable to read an image on an original such that the image data can be used by a printer having higher functionality. For example, if a printer having a color output function (color printer) and a printer having a monochromatic output function (monochromatic printer) are connected, image data for the color printer is used, and if a high-resolution printer and a low-resolution printer are connected, image data for the high-resolution printer is used.

When image data is input from an external storage device in which the image data have been stored in advance, the image reading processing described above is not needed. In this case, the image data read from the external storage device by using the reading device (not shown) may be stored as common image data into the memory 12D by carrying out reading only once.

Next, when images accumulated by the scanning service are printed, a “re-print” button 200C on the menu screen shown in FIG. 9 is pressed to select a re-print service. In the re-print service, a desired image from the images accumulated in the memory 12D of the scanner can be output again by carrying out the same processing as described in “Print Instruction Processing” described above.

In the above embodiment, an image read out by the scanner is temporarily stored in the memory 12D of the scanner 12, and when the image data thus stored is needed to be output to printers 16, the image data is transmitted from the memory 12D to the server 14 and output to the printer 16. However, at the time an image is read out from an original, the image thus read may be transmitted to the server 14 and stored therein, and then may be transmitted to the printer 16 when it is to be output to the printer 16. Alternatively, the image read out by the scanner may be temporarily stored in the memory 12D of the scanner 12, and directly transmitted from the memory 12D to the printer without passing through the server 14 when the print operation is to be carried out.

Further, the above embodiment may be modified such that the image read out by the scanning service is temporarily stored in the memory 12D of the scanner 12, and information indicating the storage place of the image is transmitted to the server 14 or the printers 16, and the server 14 or the printers 16 can read out the image on the basis of the information indicating the storage place of the image when the image is to be output from the printers 16.

In the above-described embodiment, images are output to the printers. However, the images may be output to apparatuses other than the printers, such as multifunction devices or facsimile devices. Further, the images may be output as electronic mails to other equipment connected through the network (for example, cellular phones).

Further, in the above-described embodiment, logical sums (ORs) and logical products (ANDs) are computed. However, exclusive ORs and other logical operations may be used, and plural operations may be used in combination.

(Second Embodiment)

Next, a second embodiment of the present invention will be described.

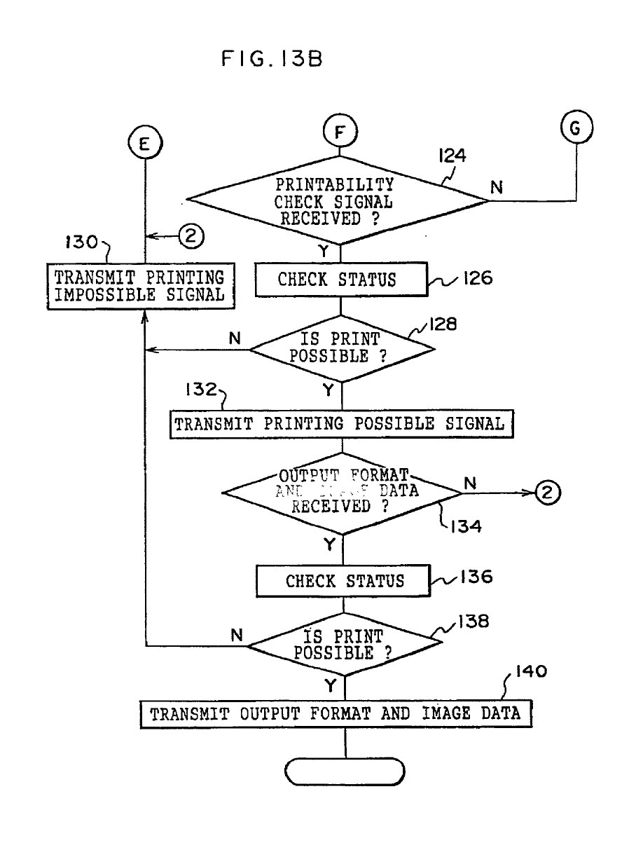

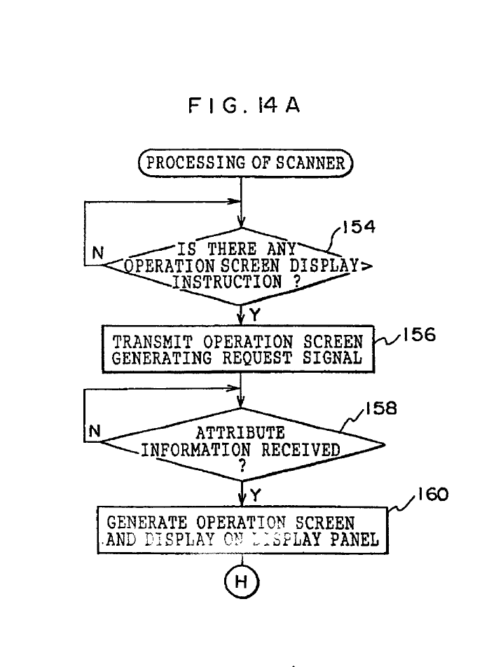

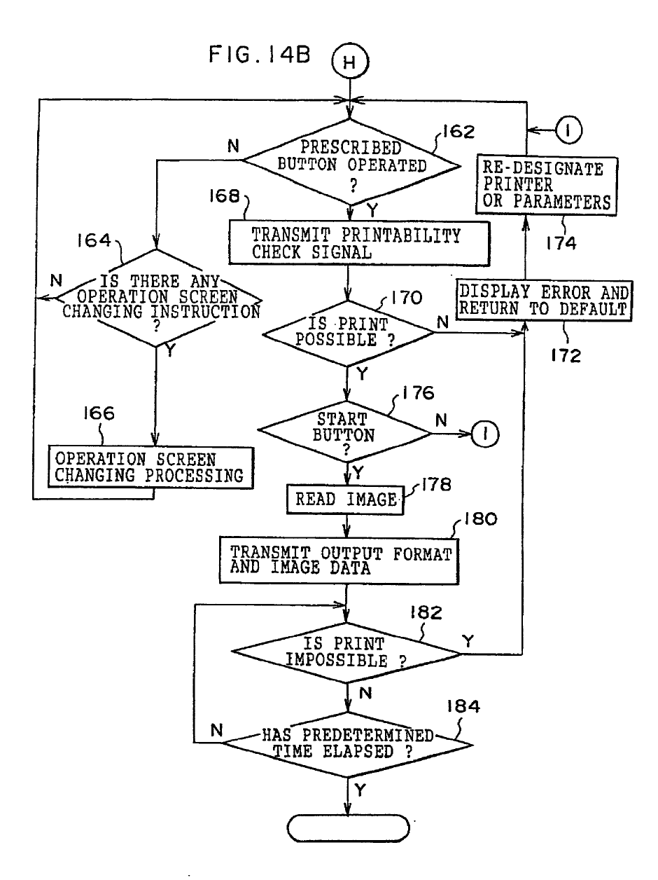

The second embodiment has the same structure as the device shown in FIGS. 1 to 4. Further, with respect to “Attribute Information Registration Processing” and “Operation Screen Display Processing”, the same processes as in the first embodiment are applied. However, the processing methods in “Print Instruction Processing” and “Print Processing” are different from the first embodiment. The differences in those two processings will be described. FIGS. 13 and 14 of the second embodiment correspond to FIGS. 6 and 7 of the first embodiment.

[Print Instruction Processing]

As in the case of the first embodiment, after checking the attribute information of the printer 16 on the print operation screen shown in FIG. 11, the operator sets the output parameters showing the image data output formats such as sheet size, magnification rate, etc. from the print operation screen and instructs the print operation.

For example, the operator can set desired parameters by operating parameter buttons displayed with icons in the parameter setting portion 208. Finally, the operator operates a start button 206 to start the image reading operation.

It is judged in step 162 of FIG. 14 (corresponding to FIG. 7 of the first embodiment) whether a desired button has been operated or not, that is, whether any one of the parameter buttons and the start button 206 has been operated or not. If it is judged that any button has been operated, a printability check signal to check whether it is possible for the designated printer 16 to carry out the print operation is transmitted to the server in step 168.

If the printability check signal is transmitted from the scanner 12 to the server 14 and it is judged in step 124 of FIG. 13 that the printability check signal has been received, the status of the designated printer 16 is checked in step 126. If in step 128 it is judged from the status thus checked that the print is possible, the printing possible signal is transmitted to the scanner 12 in step 132. On the other hand, if it is judged in step 128 that the print is impossible, the printing impossible signal is transmitted to the scanner 12 in step 130.

It is judged in step 170 of FIG. 14 in the scanner 12 whether the printing possible signal has been received or not. If the printing possible signal is received, it is judged in the next step 176 whether image reading (start scan) has been instructed by operator operation of the start button. If it is judged in step 176 that the start button has been pressed, the scanner portion 12A is controlled in step 178 to read out an image recorded on an original set and store the image as electronic image data in the memory 12D of the scanner. In step 180, the output format input from the operation screen and the image data read out by the scanner portion 12A are transmitted to the server 14. If it is judged in step 176 that the start button has not been operated, that is, if a parameter button was operated, the processing returns to step 162 and is kept on standby until the next button is operated.

On the other hand, if it is judged in step 170 that the printing impossible signal has been input, an error information is displayed to show that the output cannot be performed with the printer selected in step 172, the designation of that printer is set to a default state and the operator is advised to re-designate the printer 16 in step 174. When the operator operates the display panel 12B to re-designate the printer 16 which is to carry out the print operation, like the foregoing process, the processing goes from step 162 to step 168 to transmit to the server 14 the printability check signal to check whether the print is possible or not. If it is judged in step 170 that the printing possible signal is received and also it is judged in step 176 that the start button has been operated, the output format and the image data are transmitted to the server 14 in step 178.

When plural printers are designated by using one of the group buttons, if there is one printer that is down, or more, the server 14 transmits the printing impossible signal in step 130 of FIG. 13 (corresponding to FIG. 6 of the first embodiment). Accordingly, when the scanner 12 receives the printing impossible signal, a response other than display of error information indicating that the selected printer cannot carry out the output operation may be given. For example, when a printer that is in the down state (hereinafter referred to as a “printing impossible printer”) and other printers are selected, the printing impossible printer is displayed, and also alarm information indicating that the job operation will be switched from the printing impossible printer to the other printers and that the output will be carried out by the other printers is displayed. In addition, the settings of the parameters such as the number of output prints (copies), etc. are returned to the default state, and the operator is advised to re-do the parameters. If the job operation of the printing impossible printer cannot be switched to the other printers, error information indicating that the processing cannot be continued is displayed, the printer designation and the parameter settings are returned to the default states and the operator is advised to re-designate another printer (or printers) and re-do the parameters. If all the designated printers are down, error information indicating that the output cannot be carried out by the selected printers is displayed, the printer designation is returned to the default state, and printer re-designation is advised to the operator.

If only a printer that is already known to be down is selected when the print operation screen is generated or if a printer that is already known to be down is selected with other printers when the print operation screen is to be generated, error information indicating that the output cannot be carried out by the selected printer(s) is displayed, the printer designation is returned to the default state, the operation screen shown in FIG. 10 is displayed again and printor re-designation is prompted. Further, if a printer that is already known to be down and other printers are selected when the print operation screen is to be generated, the printing impossible printer 16 may be displayed, and alarm information indicating that the print operation screen will be generated on the basis of the printers other than the printing impossible printer 16 may be displayed. Further, the display may be modified so that the printing impossible printer 16 is not displayed, to prevent the operator from designating the printing impossible printer 16.

[Print Processing]

Until it is judged in step 134 of FIG. 13 that the output format and the image data (job) from the scanner 12 has been received by the server 14, the processing returns to step 124 to repetitively check whether the printability check signal has been received. If it is judged that the output format and the image data are received by the server 14, the status of the printer 16 that is instructed to execute the job is checked in step 136, and in step 138 it is judged on the basis of the checked status whether the print is possible or not. If it is judged that the print is impossible due to occurrence of an error in the printer 16 designated to execute the print, the printing impossible signal is transmitted to the scanner 12 in step 130, whereby, after the output format and the image data are transmitted, it is judged in the scanner 12 in step 180 that the printing impossible signal has been received. Accordingly, as described above, the operator is advised on the operation screen to re-designate another printer 16 in step 172. When the operator operates the display panel 12B to re-designates a printer 16 that will carry out the print output operation, the printing possible signal as been received. At this time, when the scan start is instructed, the image is read out and the output format and the image data are transmitted to the server 14 again. Further, the processing returns to step 180 to repetitively judge whether the printing impossible signal is received until it is judged in step 182 that a predetermined time has elapsed.

As described above, in the print system of the second embodiment, when a printer falls into a down state (printing impossible state) before the operation screen is generated, the attributes of the printing impossible printer are prevented from being displayed on the operation screen while the printing impossible printer is displayed, or the attributes of the printing impossible printer are prevented from being displayed on the operation screen and the printing impossible printer is not displayed so that it cannot be designated, whereby any job is prevented from occurring in the printing impossible printer. Further, the presence or absence of a printing impossible printer is checked every time a prescribed button is operated on the operation screen, and image data are prevented from being transmitted to the printing impossible printer by displaying the printing impossible printer or the like, thereby preventing any job from occurring in the printing impossible printer.

(Third Embodiment)

Next, a third embodiment according to the present invention will be described.

The third embodiment has the same device structure as the first and second embodiments. Further, with respect to [Attribute Information Registration Processing], [Operation Screen Display Processing] and [Print Processing], processes the same as the first and second embodiment are applied. However, the processing method of [Print Instruction Processing] is different between the third embodiment and the second embodiment. Particularly, the third embodiment is characterized by the printer designation and the output format setting processing.

[Print Instructing Processing]

Here, the printer designation and the output format setting processing of this embodiment will be described in detail by using an example of the print operation screen shown in FIG. 16. On the print operation screen, an icon 200 indicating change of the designation of the output method is displayed together with a text indicating the currently-designated output method at an upper left portion, icons 202 indicating each selectable printer 16 or group of selectable printers 16 are displayed at a lower left portion and are arranged in a column, and a reset button 204 and a start button 206 are displayed at a right portion.

At the center portion of the print operation screen are displayed icons 208 indicating selectable functions on the basis of the attribute information of the designated printer 16 or group of printers 16. For example, if the designated printer 16 has plural trays and thus the sheet size is selectable, icons 208 indicating various selectable sheet sizes are displayed arranged in a column. If the designated printer 16 has the enlarging/reducing function and thus the magnification (enlarging/reducing rate) is selectable, icons 208 indicating various selectable magnifications are displayed arranged in the vertical direction.

In the initial state, the top icons 202 or 208 of the respective columns are shown selected on the print operation screen.

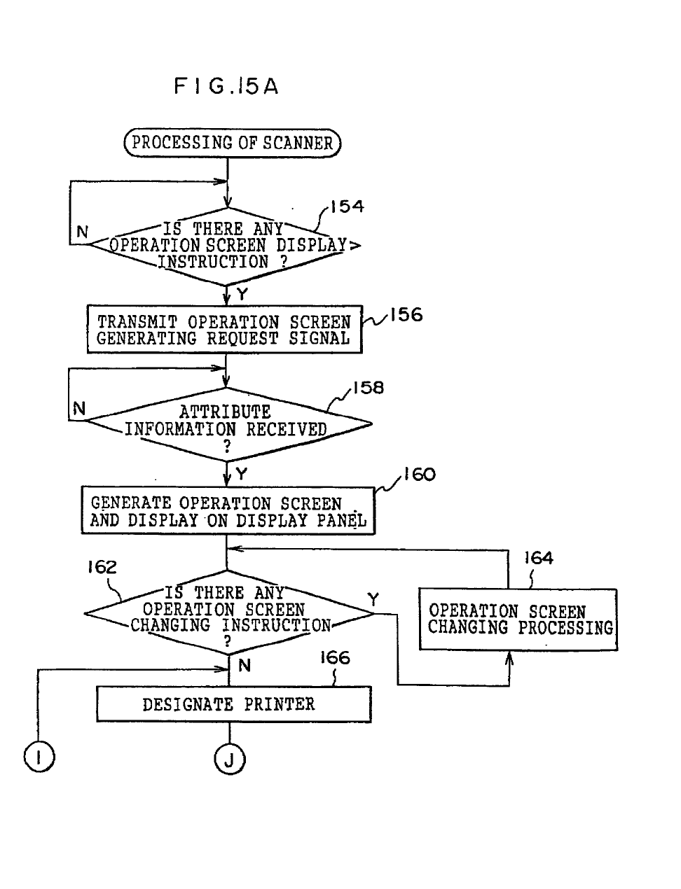

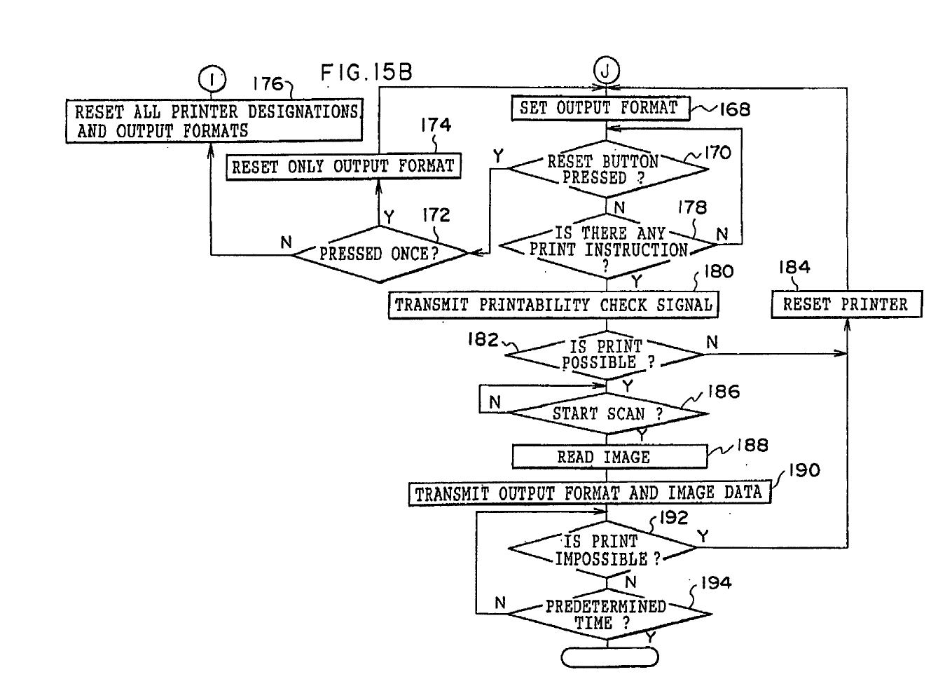

The operator selects and presses the icon 202 corresponding to the desired printer 16 or group of printers 16 to designate the printer 16 or group of printers 16 that will output images. In response to this designation, the center portion of the print operation screen is changed to the display of the selectable functions of the designated printer 16 or group of printers 16. The output format is set by operating the icons 208 to select desired functions. With this operation, the printer designation of step 166 and the setting of the output format of step 168 of FIG. 15 are carried out.

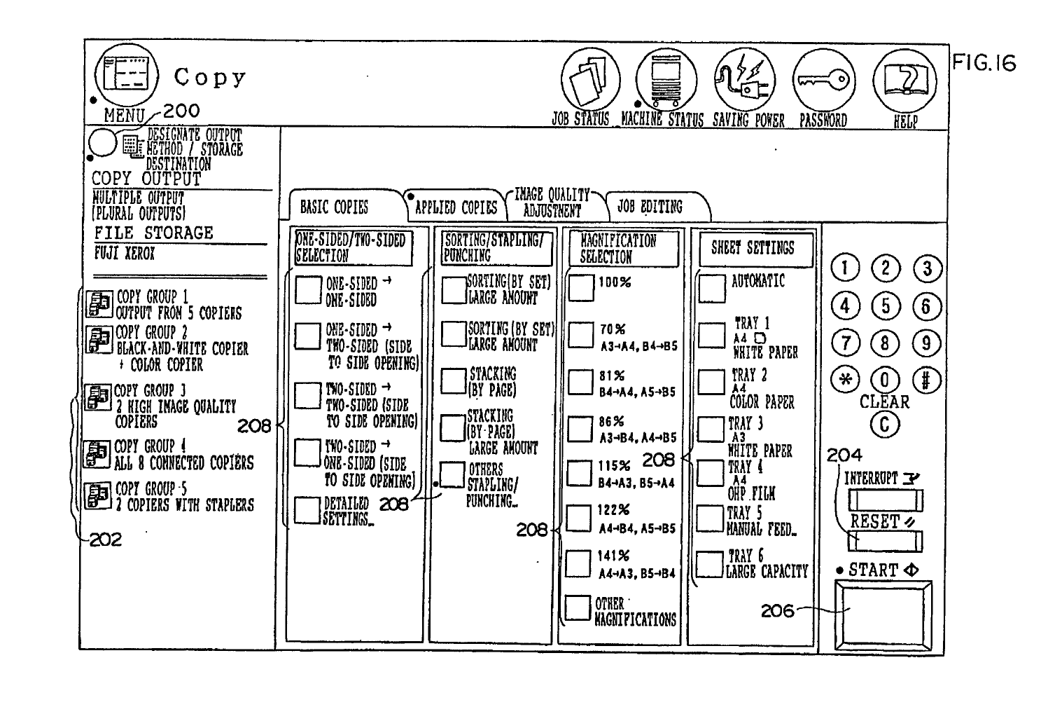

When the output method is to be changed, the display at the center portion of the print operation screen is switched as shown in FIG. 17 to display icons 210 indicating the respective selectable output methods by pressing the icons 200, so that the operator can change the designation of the output method by selecting and pressing one of the icons 210.

When the operator has erroneously set the output format and thus wants to return the settings to the initial state, after the printer designation and the output format setting have been carried out as described above or at some midpoint of the setting process of the output format, the operator presses the reset button 204 once. When the reset button 204 is pressed only once, the scanner 12 goes from step 170 of FIG. 15 to step 172 and step 174 to reset (return to initial values) only the settings of the current output format, and then returns to step 168.

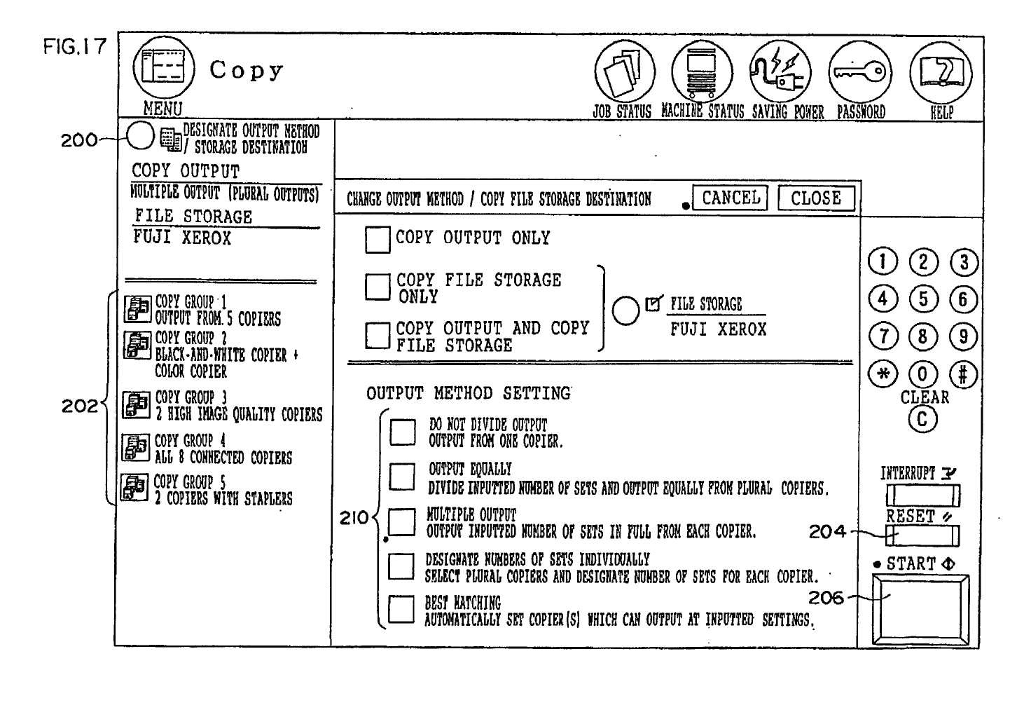

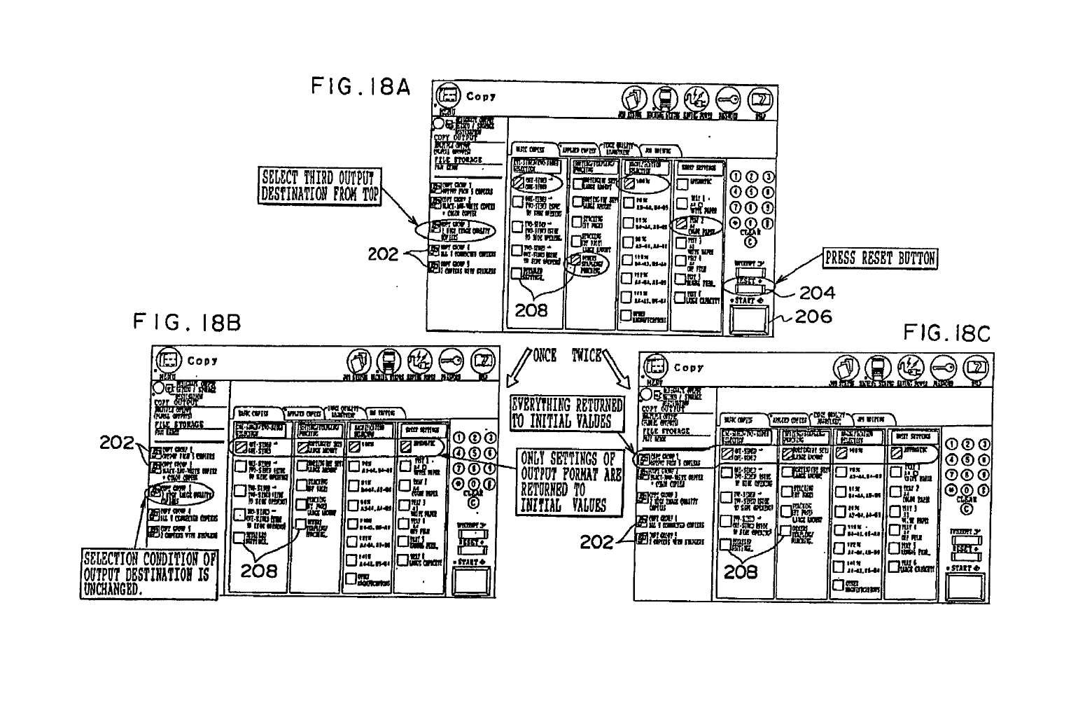

With the above operation, the selection condition of the icons 202 is left unchanged and the selection condition of the icons 202 is kept to the state before the operator's selection; that is, only the settings of the output format are returned to the initial values, as shown from FIG. 18, so that the operator can select desired functions again and re-do the output format.

If the designation of the printer is erroneous, the operator presses the reset button 204 quick twice. When the reset button 204 is pressed quickly twice, the scanner 12 goes from step 170 to steps 172 and 176 of FIG. 15 to reset the designation of the printer(s) and all the output formats currently set on the print operation screen, and then returns to step 166. When the output method is changed, the designation of the output format at this time is also reset. Accordingly, the selection condition of the all the icons 202 and 208 on the print operation screen is returned to the state before the operator's designation and setting, as shown in FIG. 18C, so that the operator can re-designate a printer again and re-do the output format.

That is, the reset button 204 functions as a partial reset means of the present invention when it is pressed only once, and functions as an overall reset means of the present invention when it is double-pressed.

FIGS. 16 to 20 show a case where the reset button 204 and the start button 206 are implemented as soft buttons. However, as shown in FIG. 19, an operation panel 12G having the reset button 204 and the start button 206 implemented as hard buttons may be provided to the scanner 12 separately from the display panel 12B. In this case too, the setting of the output format is reset by pressing the reset button only once, so that the print operation screen is switched from FIG. 19A to FIG. 19B, and all the settings of the print operation screen are reset to that of FIG. 19C by pressing the reset button twice.

In the above embodiment, the common reset button 204 having both functions as the partial reset means and the overall reset means is provided. However, two buttons that separately have the function of partial reset means and the function of the overall reset means may be provided.

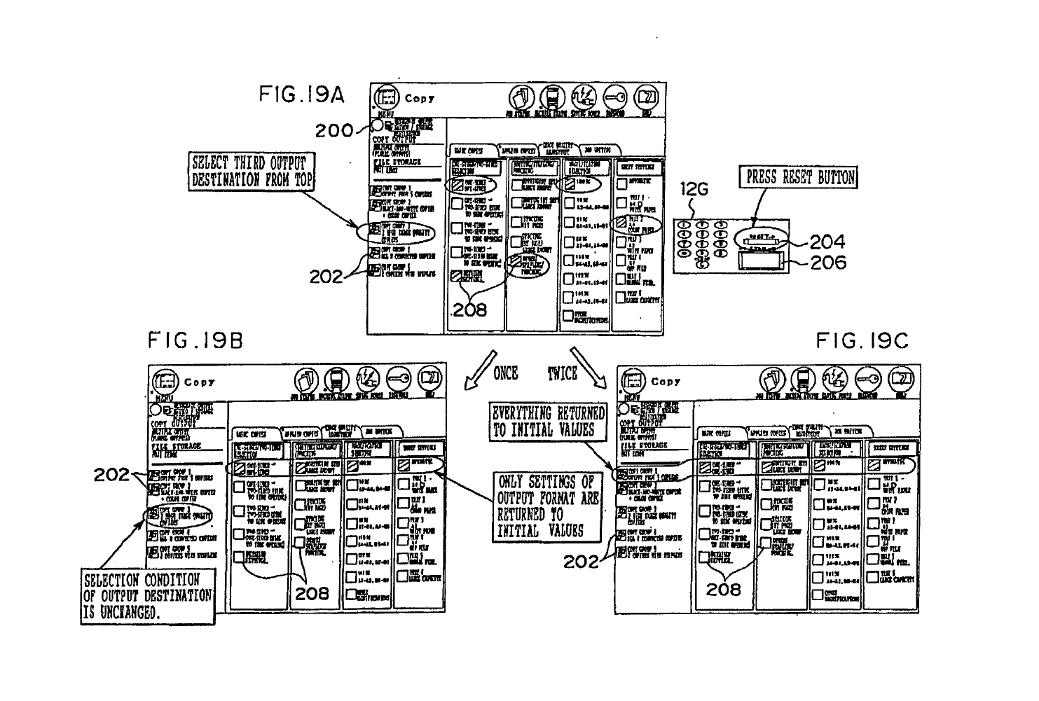

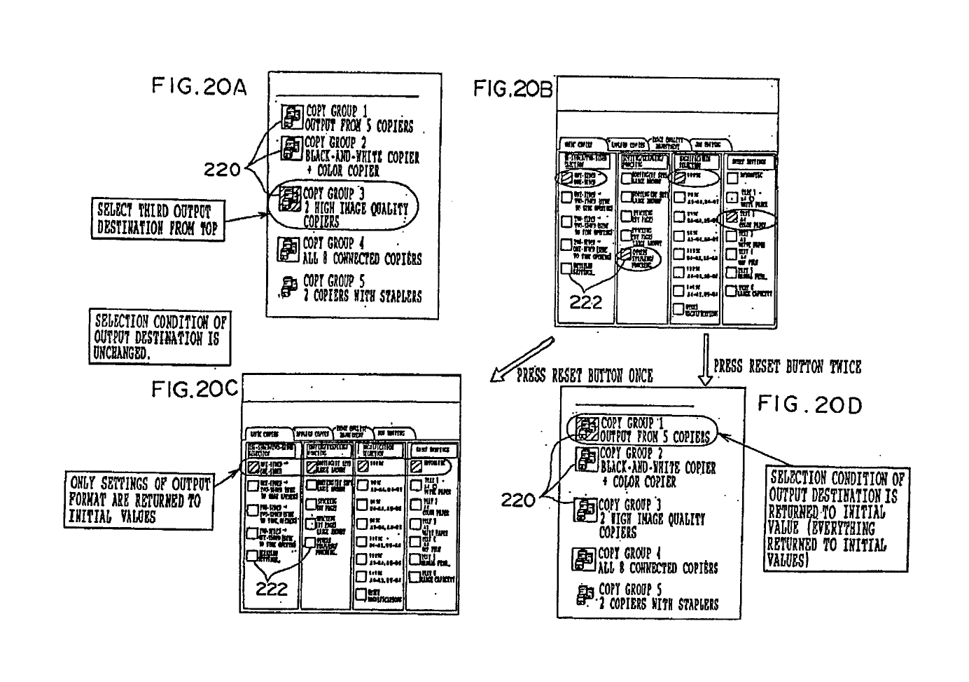

Further, the printer designation and the output format setting may be carried out on different print operation screens. FIGS. 20A to 20D show an example of a print operation screen when an output destination selecting screen (FIG. 20A), on which icons 220 indicating the printers 16 or groups of the printers 16 are displayed, and a detailed setting screen (FIG. 20B), on which icons 222 indicating selectable functions are displayed on the basis of the attribute information of the designated printer 16 or the group of the designated printers 16 are switchably displayed on the display panel 12B. The reset button 204 and the start button 206 are also provided as in the cases of FIGS. 16 to 18 and FIG. 19 although these buttons are omitted from the illustration of FIGS. 20A to 20D.

The output destination selecting screen shown in FIG. 20(A) is displayed as the print operation screen on the display panel 12B, and the display of the display panel 12B is switched to that of FIG. 20(B) by operating an icon 220 on the output destination selecting screen thus displayed, to designate a printer 16 or group of printers 16 that will carry out the print output operation. Then, the operator selects desired functions by operating icons 222 to set an output format.

When the operator erroneously sets the output format and thus wants to reset the settings to the original state after or during the setting of the output format, only the settings of the output format are reset by pressing the reset button 204 only once, and the display of the detailed settings screen is switched from that of FIG. 20B to that of FIG. 20C. When the operator wants to re-do the process from the printer indicating step, all the settings are reset together by pressing the reset button 204 quickly twice, and the display screen on the display panel 12B is switched from the detailed settings screen to the output destination selection screen as shown in FIG. 20D, and also the selecting condition of the icons 220 on the output destination selecting screen is returned to the state before the operator carried out printer designation. After the designation of the printer(s) 16 and the setting of the output format are completed, the operator presses the start button 206. Subsequent processing is the same as in the first embodiment.

As described above, in the above embodiment, if the reset button 204 is pressed once when the printer designation has been carried out and the output format has been set, the reset button 204 functions as the partial reset means, and only the output format settings are returned to the initial values, while the designation of the printer(s) (and the output method) are kept unchanged. Therefore, the operator need not redesignate the printer(s) and the output method and thus operability can be enhanced.

If the reset button 204 is pressed quickly twice, the reset button 204 functions as the overall reset means, and the designation of the printer(s) (and the output method) and the settings of the output format are returned to the initial values. Accordingly, the operator can freely designate and reset both the printer(s) (and the output method) and the output format, or reset only the output format.

The above operations may be modified so that, when the reset button 204 functions as the partial reset means, the settings of the output format are not reset, but the printer designation is reset, or the designation of the output method is reset, or so that any two of the printer designation, the output method and the output format settings are reset.

(Fourth Embodiment)

Next, a fourth embodiment of the present invention will be described.

The fourth embodiment has the same device structure as the first to third embodiments. Further, with respect to [Attribute Information Registration Processing], [Operation Screen display Processing] and [Print Processing], the same processes as in the first to third embodiments are applied in the fourth embodiment. However, the fourth embodiment newly features [Printer Group Registration Processing] and the processing method of the [Print Instruction Processing] is changed in accordance with the addition of the [Printer Group Registration Processing].

[Printer Group Registration Processing]

The printer group registration processing is a process of selecting plural printers 16 from the printers 16, which have attribute information registered in the attribute information registration processing and are connected to the network 10, and then registering these selected printers into the database as a printer group.

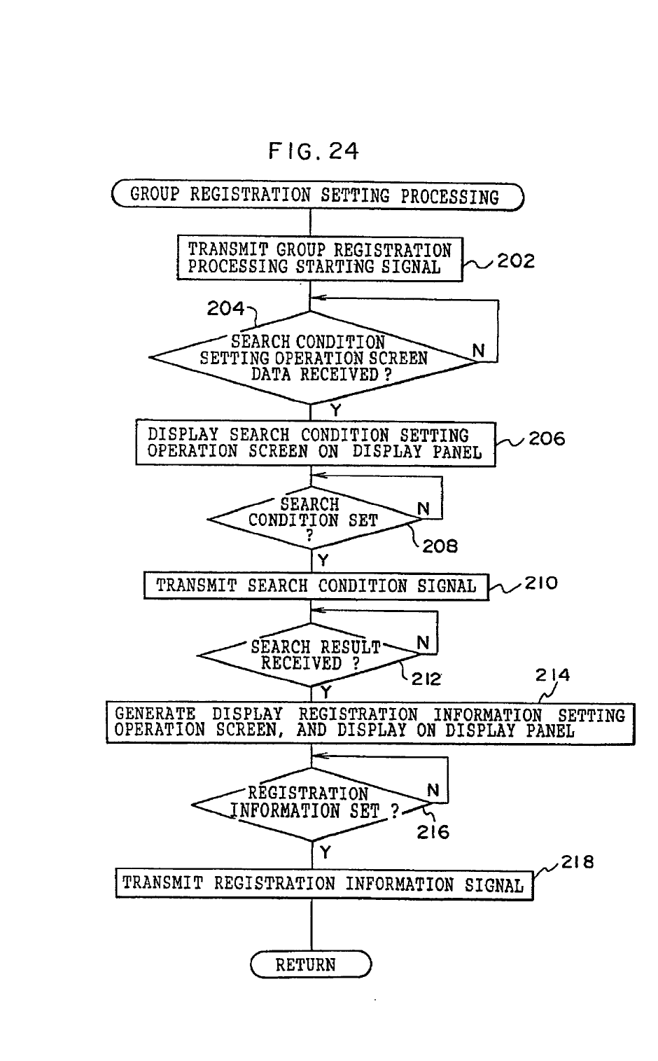

When group registration is selected from the menu displayed on the touch panel 12B of the scanner 12 by the operator, it is judged in step 148 that there is a group registration instruction, and the processing goes to step 200 and starts the group registration setting processing shown in FIG. 24. When the group registration setting processing is started, the scanner 12 first transmits a group registration processing start signal to the server 14 in step 202.

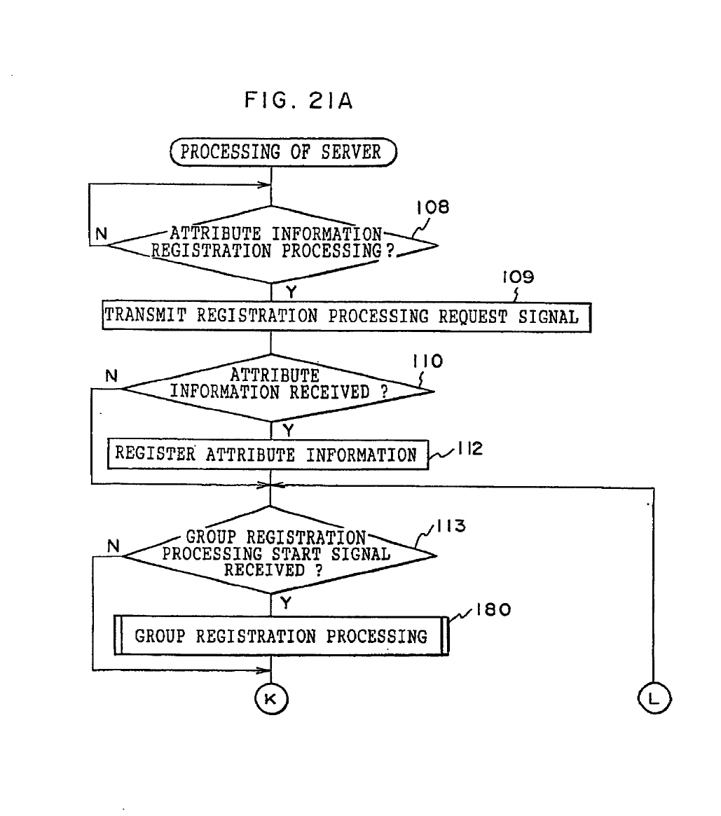

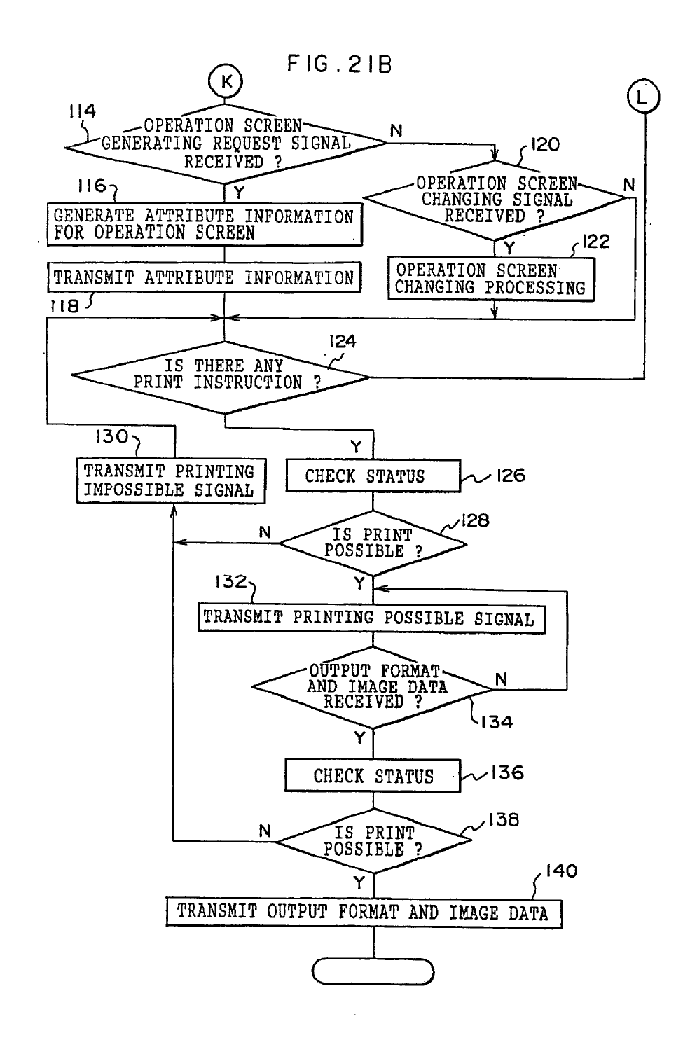

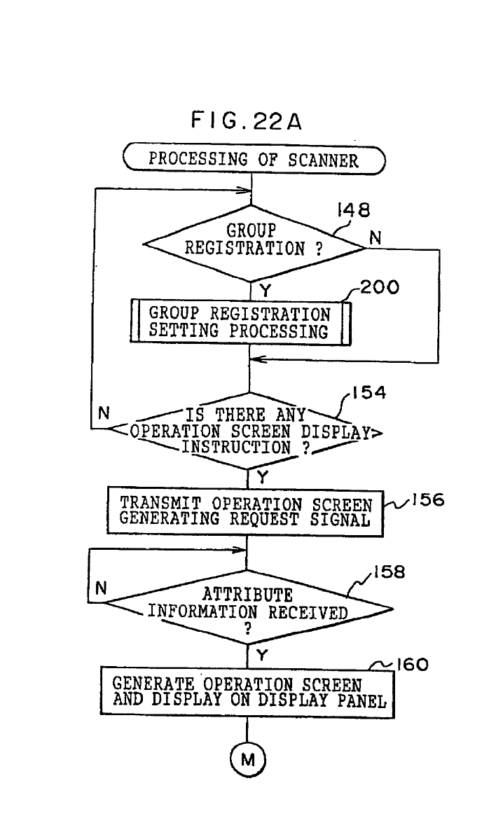

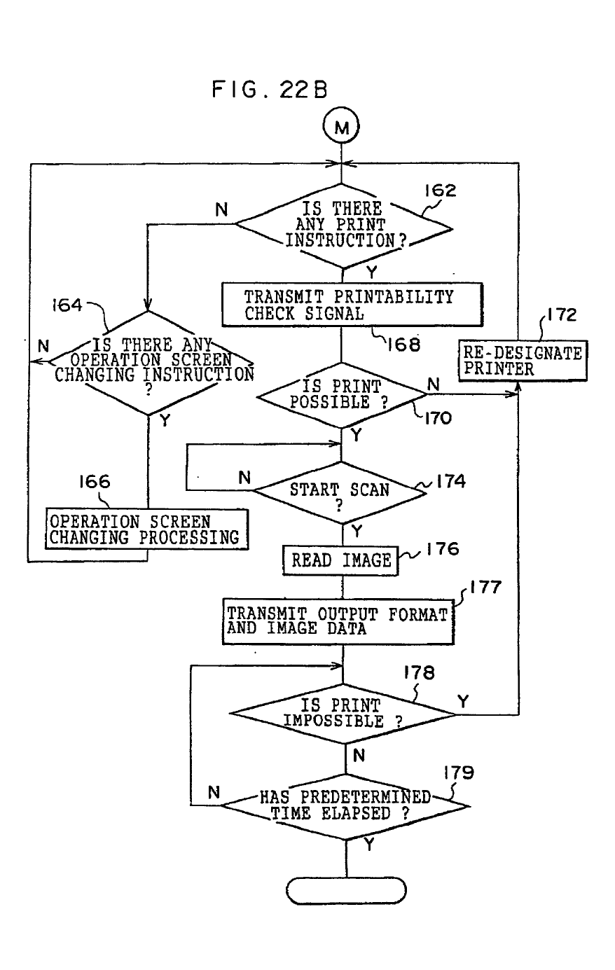

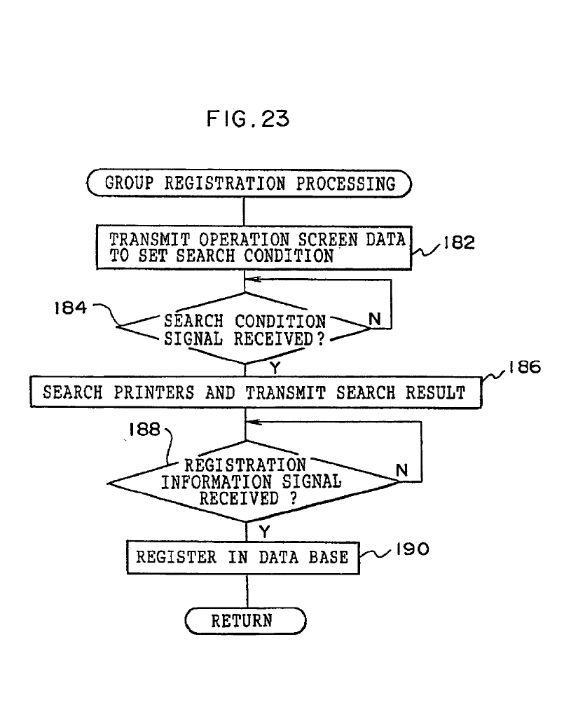

Upon receiving the group registration processing start signal, the server 14 advances its processing from step 113 of FIG. 21 to step 180 and starts the group registration processing shown in FIG. 23. When the group registration processing is started, the server 14 reads out data for a search condition setting operation screen from a memory 14B in step 182, and transmits the data to the scanner 12.

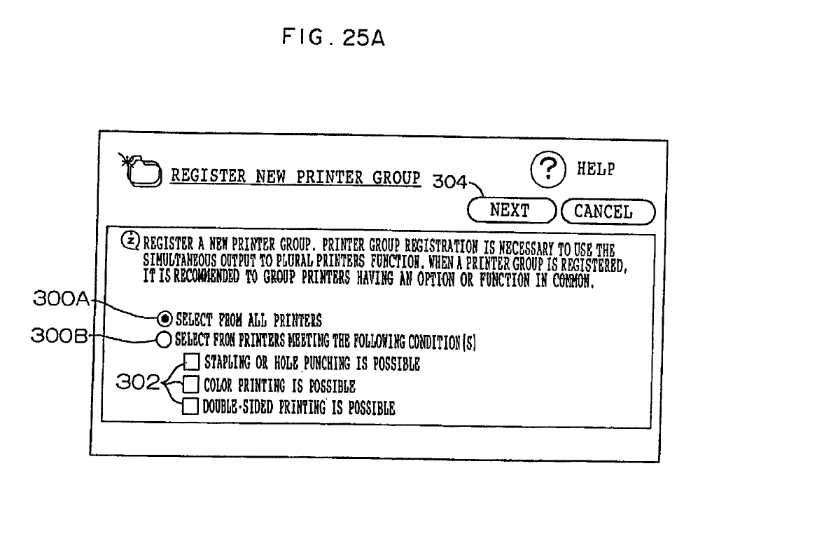

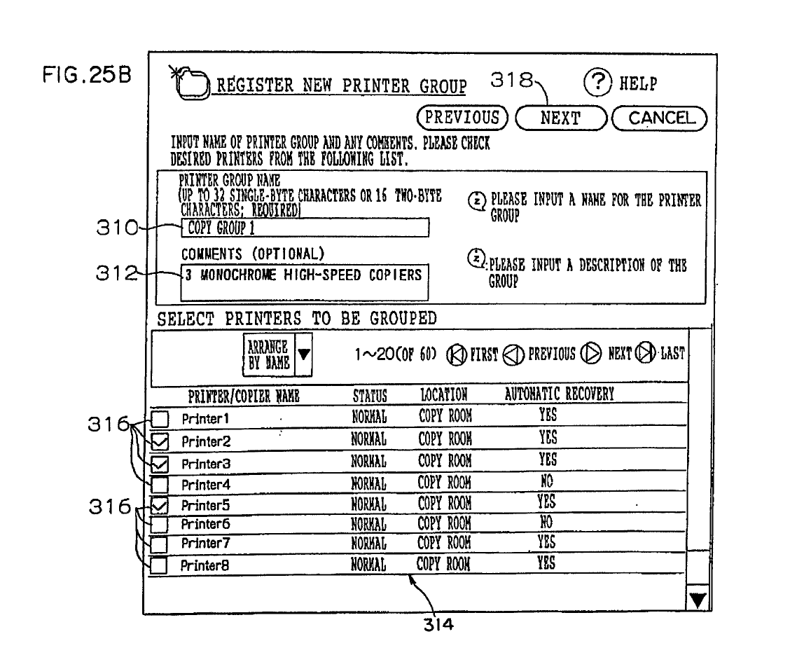

Upon receiving the data for the search condition setting operation screen data, the scanner 12 advances its processing from step 204 of FIG. 24 to step 206 and displays the search condition setting operation screen, as shown in FIG. 25A, on the display panel 12B on the basis of the screen data thus received.

The data of the search condition setting operation screen may be stored in the memory 12D provided at the scanner 12. In this case, the data for the search condition setting operation screen is read out from the memory 12D immediately after the group registration setting processing is started, and the search condition setting operation screen is displayed on the display panel 12B.

The operator sets search conditions for searching for printers 16 having desired functions (attributes) from the printers 16 connected to the network 10, by operating the search condition setting operation screen. For example, in the case of FIG. 25A, the operator presses either a radio button 300B on the search condition setting operation screen for searching for all the printers 16 or a radio button 300A for searching for printers 16 satisfying designated search conditions to set the button 300A or 300B to an ON state. When the radio button 300B is set to the ON state, check boxes 302, for functions of printers 16 which the operator wants to group (stapling or punching is available, color printing is possible, double-sided printing is possible, etc.), are provided at the lower side of the radio button 300B, for selection of specific search conditions. When the search conditions are set as described above, an icon 304 on which “next” is written is pressed.

Accordingly, in the scanner 12, it is judged in step 208 that the search conditions are set, and the processing goes to step 210 and transmits a signal indicating the search conditions thus set (in the case of FIG. 25A, any of: all printers; stapling or punching possible; color printing possible; double-sided printing possible) to the server 14.

Upon receiving the signal indicating the search condition, the server 14 advances its processing from step 184 of FIG. 23 to step 186 and refers to the attribute information of all the printers 16 registered in the database, searches for the printers 16 satisfying the search condition and transmits the attribute information of the found printers 16 to the scanner 12 as a search result.

Upon receiving the attribute information of the searched printers 16 as the search result, the scanner 12 advances its processing from step 212 of FIG. 24 to step 214. In step 214, a list of the found printers 16, that is, the printers 16 satisfying the search condition, is displayed on the basis of the attribute information thus received, and a registration information setting operation screen, as shown in FIG. 25B, is generated and displayed on the display panel 12B for selecting printers 16 that are to be registered as a group from the printers 16 displayed in the list.

The list display of the printers 16 satisfying the search condition may be a display of all the items of the attribute information, a display of a part of the attribute information, for example, only the names of the printers 16, or a display of the names of the printers 16 and locations thereof.

The operator checks the printers displayed in the form of this list on the registration information setting operation screen, selects the printers 16 that are to be registered as a group, and sets various kinds of information for the group registration. For example, in the case of FIG. 25B, the operator inputs a name of the printer group to be registered in a group name input column 310 on the registration information setting operation screen, and inputs an explanation of the printer group into an explanation input column 312, if desired. Further, the operator checks the list 314 of the printers 16 satisfying the search condition displayed on the registration information setting operation screen, and selectively presses, from check boxes 316 allocated to all the printers 16 in the list 314, the check boxes 316 corresponding to the printers 16 to be grouped, thereby selecting the printers 16 to be registered as the group. When the name of the printer group and any comments have been input and the printers 16 have been selected as described above, an icon 318 on which “next” is written is pressed.

Accordingly, in the scanner 12, it is judged in step 216 of FIG. 24 that the registration information has been set, and the processing goes to step 218 and transmit a signal indicating the input information and the printer selection information (hereinafter generically referred to as “registration information”) to the server 14, thus finishing the group registration setting processing.

Upon receiving the signal indicating this registration information, the server 14 advances its processing from step 188 of FIG. 23 to step 190 and registers the group of the printers 16 into the database on the basis of the registration information (the name of the printer group, the comments, the names of the printers 16 belonging to the printer group, etc.), thus finishing the group registration processing.

At this time, in order to simplify the operation screen display processing and the print instructing processing described later, the attribute information items of the printers 16 belonging to the group concerned may be subjected to a logical product, to select attribute information common to the respective printers and the common attribute information may be registered as registration information in the database.

The printers 16 are registered as a group by the above group registration processing. Thus, the printers 16 can be designated on a registered group basis in the operation screen display processing and the print instructing processing, as described later.

In the foregoing description, in order for the printers 16 to be registered as a group, the attribute information of each of the printers 16 connected to the network is registered (stored) in the database in advance, and the attribute information registered in the database is used when the group registration is carried out. However, when the grouping is instructed, the server 14 may detect the attribute information of each of the printers 16 connected to the network and register the printers 16 as a group using this detected attribute information.

[Print Instructing Processing]

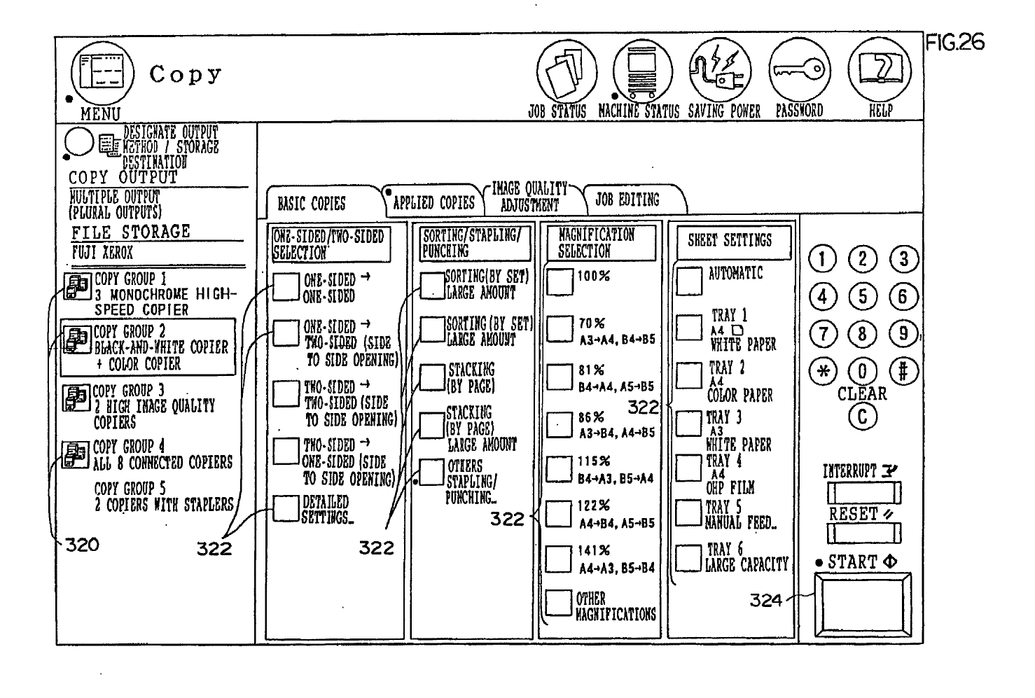

Here, the print instructing processing will be described referring to the print operation screen shown in FIG. 26.

Icons 320, each of which is allocated to a selectable group of printers 16, are displayed on the print operation screen, and the operator can select a desired group of the printers 16. Here, the selectable group of printers 16 means one of the groups of printers 16 that have been registered as groups in the printer group registration processing described above.

The operator designates a group of image-outputting printers 16 by selecting and pressing, from the icons 320, the icon 320 corresponding to a desired group of the printers 16.

When the icon 320 is pressed quickly twice, icons (not shown) of the printers 16 belonging to the group corresponding to the icon 320 are displayed. By selecting and pressing icons corresponding to desired printers 16 from the icons thus displayed, the operator can selectively designate the image-outputting printers 16 from the group.

After this operation, icons 322 indicating selectable functions are displayed at a center portion of the print operation screen on the basis of attribute information of the designated printer 16 or group of printers 16. For example, if the designated printer 16 or group of printers 16 is equipped with plural trays having various sheet sizes, icons 322 indicating the various selectable sheet sizes are displayed arranged in a column. If the designated printer 16 or group has an magnification function and the magnification/reducing rate is selectable, icons 322 indicating various selectable magnification rates are displayed in a column. The operator can set the output format by operating the icons 322 to select desired functions.

When the group of printers 16 is designated, the attribute information of the printers 16 belonging to the are is subjected to a logical product in the server 14, and attribute information common to all the printers in the group is transmitted to the scanner 12. Thus, selectable functions common to the printers 16 of the designated group are displayed with icons.

When the operator has carried out the printer designation and output format setting, the operator presses a start button 324 to input a print instruction. Subsequent processing is the same as in the first to third embodiments.

As described above, in this embodiment, when a function of the printers which the operator wants to group is selected and set as a search condition from a search condition setting operation screen displayed on the display panel 12B of the scanner 12, the printers 16 that satisfy the search condition are automatically found by the server 14, and a registration information setting operation screen, on which the list 314 of the printers 16 thus found is displayed as a choice of the printers 16 to be registered as a group, is displayed on the display panel 12B. The operator checks this display and selects the printers 16 to be grouped from the printers 16 displayed in the list, and the printers 16 having the same function (the printers 16 having a common attribute) can be grouped. Thus, the printers 16 that have a common attribute can be registered as a group simply and accurately.

The printer group registration processing is set such that interrupt processing can be executed when the operator operates the display panel 12B to input a desired signal or the like. The printers 16 can be grouped and registered at any time, even when the attribute information registration processing, the operation screen display processing, the print instruction processing, the print processing, etc. are being executed.

(Fifth Embodiment)

A fifth embodiment of the present invention will be described below.

The fifth embodiment has the same device structure as the first embodiment. Further, with respect to [Attribute Information Registration Processing], [Operation Screen Display Processing], [Print Instruction Processing] and [Print Processing], substantially the same processings as in the first embodiment are applied in the fifth embodiment. The fifth embodiment will be described by adding a further description to that of FIGS. 5, 6 and 11 using the concepts of “master job” and “slave job”.

First, in the same [Print Instructing Processing] as in the first embodiment, when output parameters indicating an image data output format have been set in FIG. 11, output processing based on the common image data is issued as a master job by the scanner 12, and output processing for a designated image output device is issued as a slave job derived from the master job and associated with the master job. That is, when the output processing is carried out by the plural printers 16 based on the common image data, plural slave jobs are provided under the master job in association with the master job. The common image data is associated with identification information, so that the master job and the slave jobs are associated with the identification information.

Further, in the [Print Processing], if it is judged in step 138 of FIG. 6 that the print is possible, an image data output format signal indicating the sheet size, the number of copies, etc. and image data input from the scanner 12 are transmitted through the network 10 to the printer 16, which is instructed to carry out the print operation by the server 14 in step 140. That is, the slave jobs are separated from the master job and are mutually associated with one another, and the slave jobs thus separated are transmitted to each of the designated printers 16.

If it is judged in step 104 of FIG. 5 that the printer has received the output format and image data transmitted from the server 14 in step 106, the printer forms an image on a recording sheet on the basis of the image data according to the output format designated. That is, the slave jobs transmitted to the printer(s) 16 are carried out.

Next, display of job status and a job operating method by which the present invention is characterized will be described.

[Display of Job Status and Operation of Job]

When the operator clicks a job status check button 200C displayed with an icon on the menu screen shown in FIG. 9 or the like and inputs the identification information, which identifies the operator, it is judged that a check of the job status has been instructed, and the following interrupt processing routine to check the job status is executed in the scanner 12.

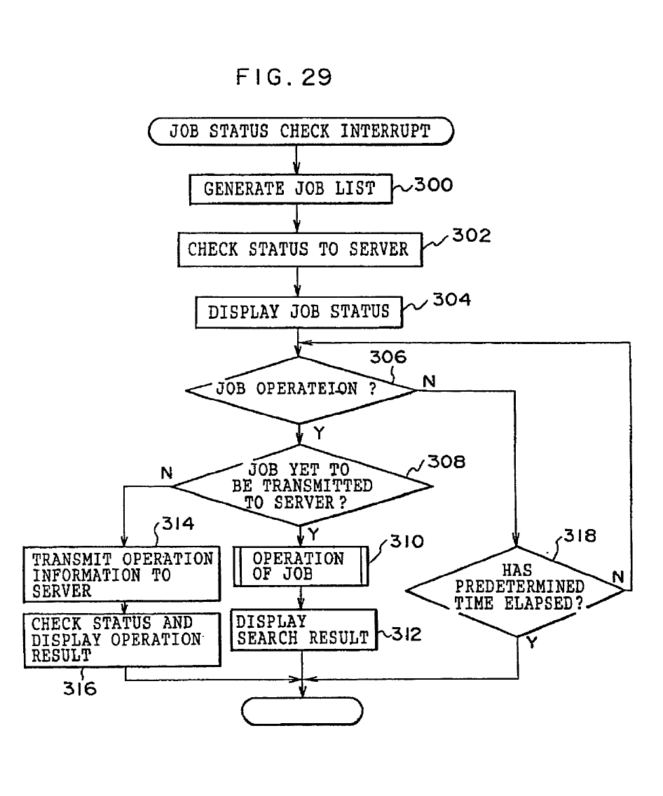

The master job and slave jobs that are associated with the identification information input in step 300 of FIG. 29 are searched to create a job list. By associating the master job and the slave jobs thus issued with the identification information, jobs of the inputting person only can be selectively listed. In the next step 302, the server 14 is instructed to check the execution state of each listed slave job. That is, a check request signal for requesting the server 14 to check the status of the printer(s) 16 to which each slave job was transmitted, or will be transmitted, is transmitted to the server 14, and then check results (job statuses) are received. In step 304, a job status check screen comprising a job list and job statuses is displayed on the display panel 12B of the scanner 12 on the basis of the check results.

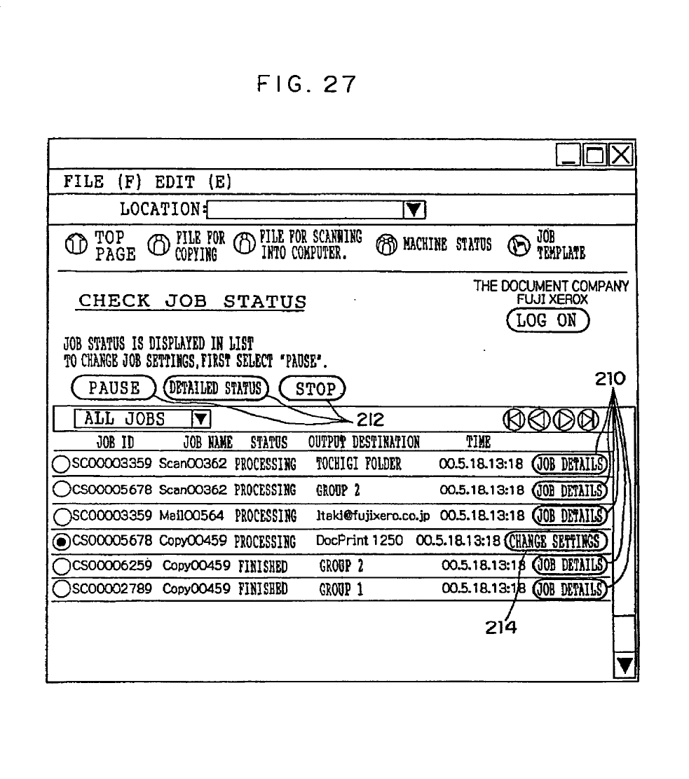

When the job status check screen is displayed, a master job status check screen to check the statuses of master jobs is displayed first. The status of each master job is displayed together with a job ID and job name of the master job, the output destination (printer name or the like), etc. on the master job status check screen, as shown in FIG. 27. The status of each master job is displayed as follows. For example, when all the slave jobs of a master job have been executed, a designation informing that the master job has been completed such as “Finished” is displayed. When there are some slave jobs which have not yet been executed, an indication informing that the master job is being processed such as “Processing” is displayed.

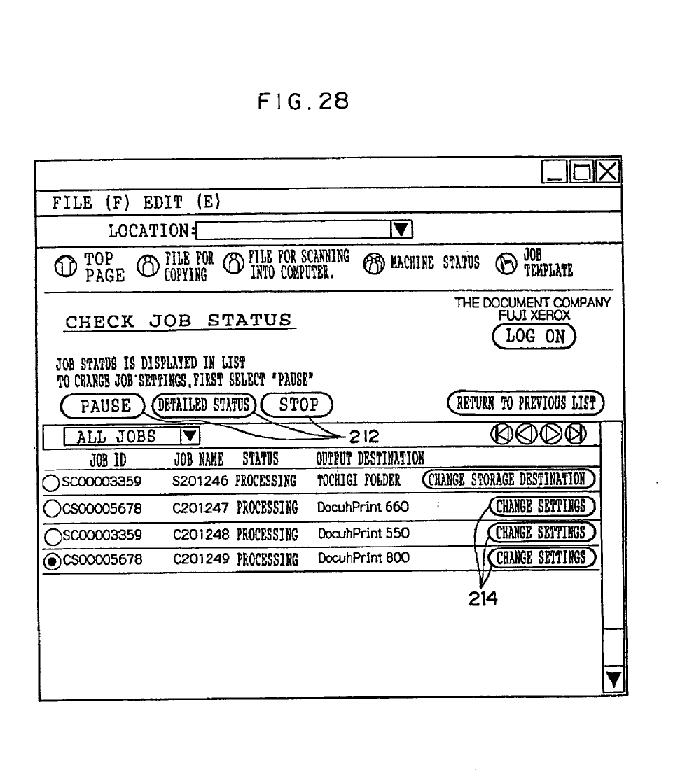

Detailed job check buttons 210, which are displayed with an icon for each master job, are provided on the master job status check screen. By clicking one of the detailed job check buttons 210, the screen of the display panel 12B is further switched and a slave job status check screen, as shown in FIG. 28, is displayed. A job ID and job name of each slave job, output destinations (printer names, etc.) and the statuses of the slave jobs are displayed. The status of each slave job is displayed as follows. For example, when the execution of a slave job has been completed, an indication “Finished”, which designates that the slave job has been completed, is displayed. When the execution of the slave job has not yet been completed, an indication “Processing”, which indicates that the slave job has not yet been completed, is displayed.

As described above, the operator displays the job list indicating the job status on the display panel 12B of the scanner 12 to easily check the statuses of the master jobs and the slave jobs. If no job has been transmitted to the printers 16, the execution of all the jobs has not been completed. In this case, an designation that all the master jobs and the slave jobs are being processed will be displayed unless a particular operation is carried out.

Command buttons 212, which are displayed with icons to control jobs, are provided on the job status check screen as shown in FIGS. 27 and 28. By clicking the command buttons 212, commands for starting a job, temporarily stopping a job, resuming a job, canceling (deleting) a job, changing the settings of a job, etc. can be input.

When the operator selects a desired master job or slave job from a job list and clicks a command button 212 to instruct control of the job, it is judged in step 306 of FIG. 29 that control of the job has been instructed, and it is judged in step 308 whether the job has been transmitted to the server 14 yet or not. If it is judged that the job has not been transmitted to the server 14, the job held in the scanner 12 is controlled in accordance with the input command and the control result is displayed on the display panel 12B in step 312. On the other hand, if it is judged in step 308 that the job has been transmitted to the server 14, the control information to instruct the control of the job is transmitted to the server 14 in step 314, a status of the printer(s) 16, which is transmitted from the server 14, is checked in step 316, and the control result is displayed on the display panel 12B. If the control of the job has not been instructed after a predetermined time has elapsed from the time when the job list was displayed in step 318, the interrupt processing routine finishes.

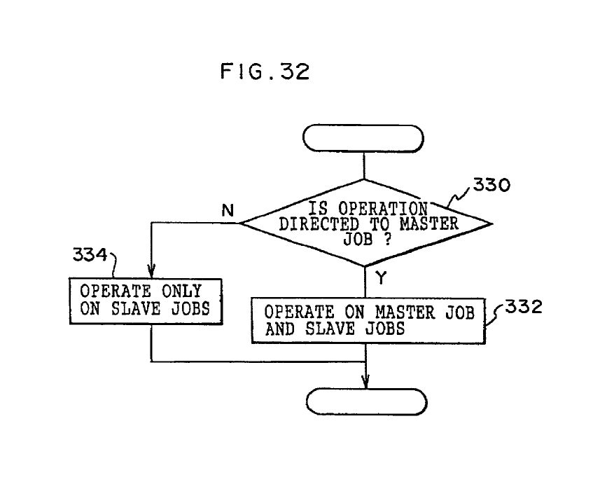

Next, the control of the job of step 310 carried out by the scanner 12 will be described in more detail with reference to FIG. 32.

It is judged whether the job operation instructed in step 330 is directed to a master job, and, if a positive judgment is made, the master job and its slave jobs are controlled in step 332. For example, if canceling of the master job is instructed, this command is effective to the master job and the slave jobs, and all of the master job and the slave jobs associated with this master job are canceled. On the other hand, if it is judged that the job operation instructed in step 330 is directed to slave jobs, in step 334 only designated slave jobs are controlled. For example, if the slave jobs are instructed to be canceled, this command is effective to only the slave jobs, and only the slave jobs that are instructed to be canceled are canceled.

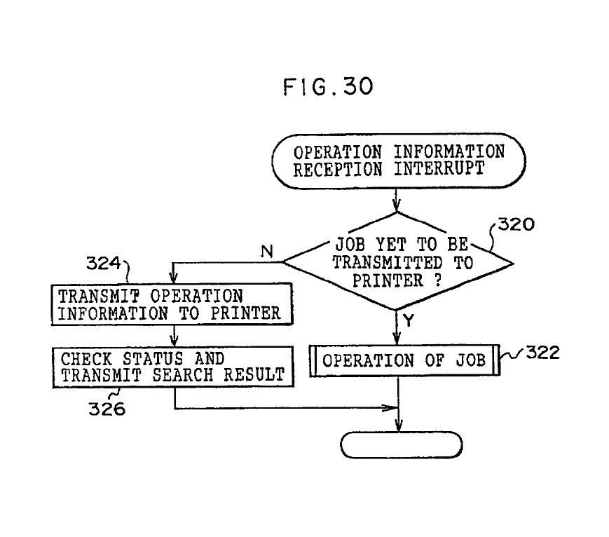

When the server 14 receives the control information from the scanner 12, an interrupt processing routine based on the reception of the control information is executed in the server 14 as described below. In step 320 of FIG. 30, it is judged whether the job has been transmitted to the printer(s) 16. If it is judged that no job has been transmitted to the printer(s) 16, the jobs held in the server 14 are controlled in accordance with the input command in step 322. The job control is carried out in the same manner as the job control in the scanner 12. On the other hand, if it is judged in step 320 that the job has already been transmitted to the printer(s) 16, the server 14 transmits the control information for instructing the job control to the printer(s) 16 in step 324, checks the statuses of the printer(s) 16 in step 326 and transmits the control result to the scanner 12.

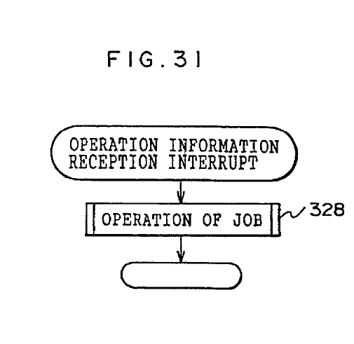

When the printer(s) 16 receive the operation information, in the printer(s) 16, it is judged that a job control has been instructed, and an interrupt processing routine based on the reception of the operation information is executed as described below. That is, in step 328 of FIG. 31, the printer(s) 16 control the jobs held in the printer(s) 16 in accordance with the input command. The job control is carried out in the same manner as the job operation in the scanner 12.

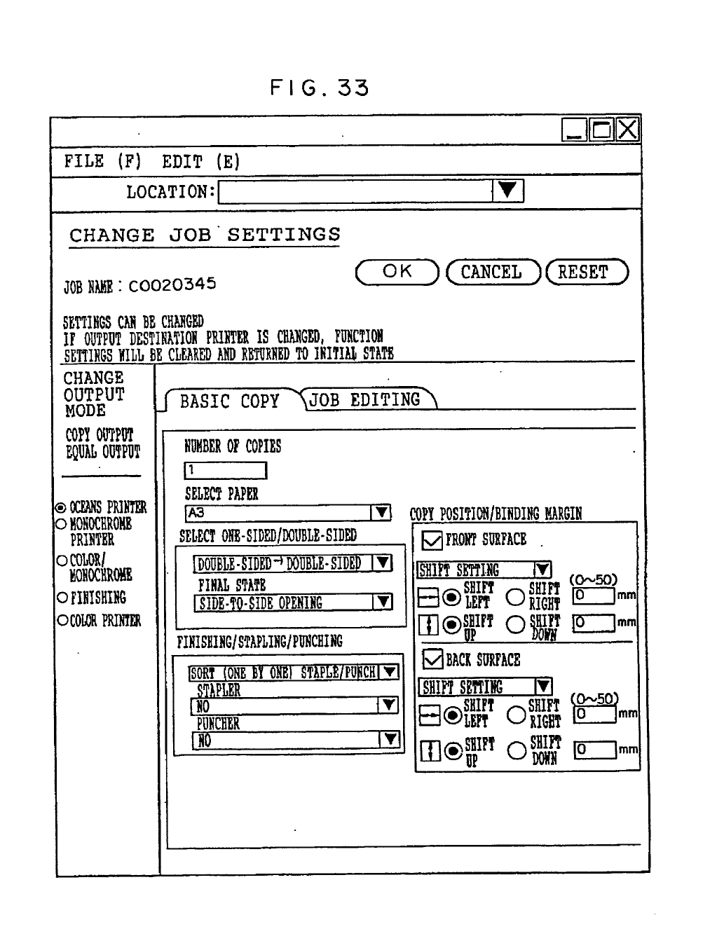

When a setting of the job is changed, the slave job status check screen shown in FIG. 28 is displayed on the display panel 12B of the scanner 12. A change settings button 214 displayed with an icon is provided for each slave job on the screen, and the screen is switched by clicking the setting change button 214 to display a setting change input screen for the slave job as shown in FIG. 33. Setting changes can be input from this screen and the changes of the job setting can be instructed. If there is only one slave job associated with the master job, the change settings button 214 is provided on the master job status check screen shown in FIG. 27.

As described above, in the print system according to this embodiment, job status check screens of master jobs and slave jobs are displayed on the display panel of the scanner when plural printers are instructed to perform the jobs, so that checking of the job status of each printer can be performed easily.

Further, commands for each of the master jobs and the slave jobs can be input from the job status check screens, so that job controls (start, stop, resume, change and cancel) can be performed easily. For example, an overall job operation containing slave jobs can be canceled by a cancel command to the master job, or each slave job can be individually canceled by a cancel command to the each slave job.

Still further, by associating a master jobs and slave jobs thereof with identification information for identifying an inputting person, only the master job and slave jobs that are associated with the identification information can be listed, and the inputting person can more simply check the statuses of his/her jobs.

What is claimed is:

1. A method of displaying a screen for operating a plurality of image output devices that each have different attributes, the method comprising the steps of:
performing a logical operation of the attributes of the image output devices; and
displaying a screen based on the result of the logical operation.

2. The method of claim 1, wherein the logical operation is a logical product (AND) operation or logical sum (OR) operation.

3. The method of claim 1, wherein the logical operation is carried out for every attribute of said plural image output devices.

4. An image input device for use in an image output system, wherein the image output system includes plural image output devices connected to a network and outputs images on the basis of image data and image output format information transmitted through the network, the image output system further including an image output managing device connected to the network, which transmits an operation screen generating signal to generate, on the basis of the attribute information of each of the plural image output devices, at least one of a first operation screen for displaying attribute information common to plural image output devices satisfying a designated condition and a second operation screen for displaying all the attribute information of the plural image output devices satisfying the designated condition, and transmits information on the output format of an image received through the network and the image data to a designated image output device, wherein said image input device includes:
an image data input device for inputting the image data;
a display input device for inputting information to designate a condition for an operation screen to be displayed, displaying thereon at least one of the first operation screen for displaying the attribute information common to the plural image output devices satisfying the designated condition and the second operation screen for displaying all the attribute information of the plural image output devices satisfying the designated condition generated on the basis of the operation screen generating signal, and inputting, from the displayed operation screen, information to designate an image output device from which the image is output and information on the output format of the image to be output from the designated image output device; and
a transceiver that is connected to the network and transmits the information input from the display input device and the image data input from the image data input device through the network and also receives the operation screen generating signal through the network.

5. The image input device of claim 4, wherein when the number of attributes to be displayed on said operation screen at least equals a predetermined value, excessive attributes beyond the predetermined value are displayed below one attribute.

6. The image input device of claim 5, wherein an interface is provided, with the excessive attributes displayed in detail in accordance with an operation carried out using said interface.

7. An image output managing device for use in an image output system including:
plural image output devices that are connected to a network and output images on the basis of image data and information on image output formats transmitted through said network;
an image data input device for inputting the image data;
a display input device for inputting information to designate a condition for an operation screen to be displayed, displaying thereon at least one of a first operation screen for displaying attribute information common to plural image output devices satisfying a designated condition and a second operation screen for displaying all the attribute information of the plural image output devices satisfying the designated condition, the first and second operation screens being generated on the basis of an operation screen generating signal, and inputting, from the displayed operation screen, information to designate an image output device from which the image is output and information on the output format of the image to be output from said designated image output device; and
a transceiver that is connected to the network and transmits the information input from said display input device and the image data input from said image data input device through said network to the image output managing device and also receives a signal to generate said operation screen through said network, wherein said image output managing device is connected to said network, transmits an operation screen generating signal for generating at least one of the first operation screen for displaying the attribute information common to said plural image output devices satisfying the designated condition and the second operation screen for displaying all the attribute information of said plural image output devices satisfying the designated condition on the basis of the attribute information of each of said plural image output devices, and transmits the information on the output format of the image and the image data received through said network to a designated image device.

8. The image output managing device of claim 7, wherein when all the attributes of said image output devices satisfying the condition are displayed on said operation screen, one of the image output devices is selected on the basis of the output format information input from said operation screen.

9. An image output system comprising:
a plurality of image output devices connected to a network that output images on the basis of image data and image output format information transmitted through the network;
an image data input device for inputting the image data;
a display input device for inputting information to designate a condition, in response to a signal for displaying thereon an operation screen for the image output devices of at least one of a first operation screen displaying attributes common to the image output devices satisfying the condition, and a second operation screen displaying all attributes of the image output devices satisfying the condition, and inputting from the displayed operation screen, information to designate from which image output device to output an image and output format information for the image to be output from the designated image output device; and
a transceiver and image output managing device connected to said network, wherein the image output managing device transmits said signal, and the transceiver receives the signal and transmits image data and information input from said display and image data input devices through said network to the image output managing device, and the image output managing device transmits the image data and information to a designated image output device.

10. A user interface device for selecting an image output device of a plurality of image output devices connected to a network, the user interface device comprising an operation screen displaying the image output devices for selection, which are connected to the network and available for image output, on the basis of attribute information of each of the image output devices.

11. An image input device for use in an image output system, wherein the image output system includes a plurality of image output devices connected to a network and that output images on the basis of image data and output image format information, and an image output managing device connected to the network, which checks status of the image output devices, and transmits a signal for generating an operation screen on the basis of only attribute information of each one of the image output devices available for image output, the image input device comprising:
an image data input device for inputting the image data;
a display input device for displaying said operation screen, and inputting from said operation screen, information indicating image output devices for outputting images and image output format information for images to be output from said designated image output devices; and
a transceiver connected to the network that transmits the information and image data input from said display input device through the network to said image output managing device and receives the signal for generating said operation screen through said network.

12. An image input device for use in an image output system, wherein the image output system includes a plurality of image output devices connected to a network and that output images on the basis of image data and output image format information, and an image output managing device connected to the network that transmits a signal for generating an operation screen on the basis of attribute information of each of the image output devices available for image output, the image input device comprising:
an image data input device for inputting the image data;
a display input device for displaying said operation screen, and inputting from said operation screen, information indicating image output devices for outputting images and image output format information for images to be output from said designated image output devices; and
a transceiver connected to the network that requests status checks during predetermined operation of said operation screen, and transmits the information and image data input from said display input device through the network to said image output managing device when image output devices available for image output are designated, and receives the signal for generating said operation screen through said network.

13. An image output managing device for use in an image output system, the device comprising:
a plurality of image output devices connected to a network that output images on the basis of image data and image output format information transmitted through the network;
an image data input device for inputting the image data;
a display input device for displaying in response to a signal, an operation screen and inputting from the operation screen, information to designate from which image output devices to output images and output format information for the images to be output from the designated image output devices; and
a transceiver to said network, wherein the transceiver transmits image data and information input from said display and image data input devices through said network to the image output managing device, and the image output managing device checks the status of the image output devices, and transmits the signal for generating the operation screen on the basis of only the attribute information of each image output device that is available for image output, and transmits the image data and information to the designated image output devices.

14. An image output managing device for use in an image output system, the device comprising:
a plurality of image output devices connected to a network that output images on the basis of image data and image output format information transmitted through the network;
an image data input device for inputting the image data;
a display input device for displaying in response to a signal, an operation screen and inputting from the operation screen, information to designate from which image output devices to output images and output format information for the images to be output from the designated image output devices; and
a transceiver connected to said network, wherein when image output devices available for image output are designated, the transceiver transmits on the basis of status of image output devices, image data and information input from said display and image data input devices through said network to the image output managing device, and the image output managing device transmits the signal for generating the operation screen on the basis of attribute information of each of the image output devices, requests status checks for designated image output devices during predetermined operation of the operation screen, and when image output devices available for image output are designated, transmits the image data and information to the designated image output devices.

15. An image output system comprising:
a plurality of image output devices connected to a network that output images on the basis of image data and image output format information transmitted through the network;
an image data input device for inputting the image data;
a display input device for displaying in response to a signal, an operation screen and inputting from the operation screen, information to designate from which image output devices to output images and output format information for the images to be output from the designated image output devices; and
a transceiver and image output managing device connected to said network, wherein the transceiver transmits image data and information input from said display and image data input devices through said network to the image output managing device, and the image output managing device checks the status of the image output devices, and transmits the signal for generating the operation screen on the basis of only the attribute information of each image output device that is available for image output, and transmits the image data and information to the designated image output devices.

16. An image output system comprising:
a plurality of image output devices connected to a network that output images on the basis of image data and image output format information transmitted through the network;
an image data input device for inputting the image data;
a display input device for displaying in response to a signal, an operation screen and inputting from the operation screen, information to designate from which image output devices to output images and output format information for the images to be output from the designated image output devices; and
a transceiver and image output managing device connected to said network, wherein when an image output device available for image output is designated, the transceiver transmits image data and information input from said display and image data input devices through said network to the image output managing device, and the image output managing device requests status checks for a designated image output devices during predetermined operation of the operation screen, transmits the signal for generating the operation screen on the basis of attribute information of each image output device, and transmits the image data and information from said transceiver to the designated image output device.

17. An input control device for use in an image output system, wherein the image output system includes a plurality of image output devices connected to a network, the input control device comprising logic that accepts input of information for indicating an image output device for image output and image format information for the image to be output, and a partial reset instruction to return a part of the information input to an initial value, and only one of the information for indicating said image output device and the image format information is returned to an initial value when the partial reset instruction is accepted.

18. An input control device for use in an image output system, wherein the image output system includes a plurality of image output devices are connected to a network, the input control device comprising logic that accepts input of information for indicating an output method for an image, information for indicating an image output device in conformity with the designated output method, and output format information of an image to be output from the designated image output device, and a reset instruction to return a part of the information input to an initial value, and when the partial reset instruction is accepted, any one or only two of the information for indicating the output method, the information for indicating said image output device and the output format information are returned to initial values.

19. The input control device of claim 17, wherein the logic further accepts an overall reset instruction to return all the information input to initial values, and when the overall reset instruction is accepted, all the information input is returned to initial values.

20. The input control device of claim 18, wherein the logic further accepts an overall reset instruction to return all the information input to initial values, and when the overall reset instruction is accepted, all the information input is returned to initial values.

21. An input control method for use in an image output system, wherein the image output system includes a plurality of image output devices connected to a network, the method comprising the steps of:
accepting input of information for indicating an image output device for image output and image format information for the image to be output;
accepting a partial reset instruction to return a part of the information input to an initial value; and
when the partial reset instruction is accepted, returning only one of the information for indicating said image output device and the image format information to an initial value.

22. An input control method for use in an image output system, wherein the image output system includes a plurality of image output devices connected to a network, the method comprising the steps of:
accepting input of information for indicating an output method for an image, information for indicating an image output device in conformity with the designated output method, and image format information for the image to be output;
accepting a reset instruction to return a part of the information input to an initial value; and
when the partial reset instruction is accepted, returning any one or two of the information for indicating the output method, the information for indicating said image output device, and the image format information to initial values.

23. The input control method of claim 21 further comprising the steps of accepting an overall reset instruction to return all the information input to initial values; and when the overall reset instruction is accepted, returning all the information input to initial values.

24. The input control method of claim 22 further comprising the steps of accepting an overall reset instruction to return all the information input to initial values; and when the overall reset instruction is accepted, returning all the information input to initial values.

25. An image output system comprising: a plurality of image output devices for outputting an image on the basis of image data and image output format information, and an image input device for inputting the image data, each of said plural image output devices and said image input device being connected to a network;
a display input portion for displaying an operation screen and inputting information for indicating from said operation screen, an image output device for outputting the image and image output format information for an image to be output from the designated image output device; and
a partial reset portion for returning to an initial value only one of the information for indicating said image output device and the image output format input from said display input portion upon operation thereof.

26. An image output system comprising: a plurality of image output devices for outputting an image on the basis of image data and image output format information, and an image input device for inputting image data, each of which is connected to a network;
a display input portion for displaying an operation screen and inputting from said operation screen, information for indicating an output method of the image information for indicating an image output device outputting the image in conformity with the output method thus designated and information on an output format of the image to be output from said designated image output device; and
a partial reset portion for returning to an initial value or initial values any one or only two of the information for indicating the output method, the information for indicating said image output device and the image output format information input from said display input portion upon operation thereof.

27. The image output system of claim 25 further comprising an overall reset portion for returning all of the information input from said display input portion to predetermined initial values.

28. The image output system of claim 26 further comprising an overall reset portion for returning all of the information input from said display input portion to predetermined initial values.

29. An image output system comprising:
a plurality of image output devices each of which is connected to a network, and outputs an image on the basis of image data and image output format information transmitted through said network;
an image input device including image data input means for inputting the image data, display input means for displaying an operation screen and inputting from said operation screen for indicating an image output device to output an image, and image output format for the image partial reset portion for returning to an initial value any one of the information for indicating said image output device and the image output format information input from said display input portion; and a transmission portion that is connected to said network and transmits through said network the image data input from said image data input means and the information input from said display input means; and
an image output managing device that is connected to said network, transmits the image data and the image output format transmitted from said transmission portion to the designated image output device.

30. An image output system comprising:
a plurality of image output devices each of which is connected to a network and outputs an image on the basis of image data and image output format information of an image transmitted through said network;
an image input device including image data input portion for inputting image data, a display input portion for displaying an operation screen and inputting from said operation screen, information for indicating an output method of an image, information for indicating an image output device outputting the image in conformity with the designated output method and image output format information for the image to be output from said designated image output device, a partial reset portion for returning any one or only two of the information for indicating the output method, the information for indicating said image output device and the image output format information input from said display input portion to initial values upon operation thereof, and a transmission portion that is connected to said network, and transmits the image data input from said image data input portion and the information input from said display input portion; and
an image output managing device that is connected to said network, and transmits the image data and the information on the output format of the image transmitted from said transmission portion to said designated image output device.

31. The image output system of claim 29 further comprising an overall reset portion for returning all the information items input from said display input portion to predetermined initial values upon operation thereof.

32. The image output system of claim 30, further comprising an overall reset portion for returning all the information items input from said display input portion to predetermined initial values upon operation thereof.

33. An image input device for connection to an image output system through a network, wherein the image output system includes a plurality of image output devices connected to the network for outputting an image on the basis of image data and image output format information, thereby constituting an image output system, the image input device comprising:
an image data input portion for inputting the image data;
a display input portion for displaying an operation screen and inputting from said operation screen, information for indicating an image output device for outputting an image and image output format information for the image to be output from the designated image output device; and
a partial reset portion for returning only one of the information for indicating said image output device and the image output format information input from said display input portion to an initial value.

34. An image input device for connection to an image output system through a network, wherein the image output system includes a plurality of image output devices connected to the network for outputting an image on the basis of image data and image output format information, thereby constituting an image output system, the image input device comprising:
an image data input portion for inputting the image data;
a display input portion for displaying an operation screen and inputting from said operation screen information for indicating an output method of an image, information for indicating an image output device outputting the image in conformity with the designated output method, image output format information for the image to be output from said designated image output device; and
a partial reset portion for returning any one or only two of the information for indicating the output method, the information for indicating said image output device and the image output format information input from said display input means to initial values upon operation thereof.

35. The image input device of claim 33 further comprising overall reset means for returning all of the information input from said display input means to predetermined initial values upon operation thereof.

36. The image input device of claim 34 further comprising overall reset means for returning all of the information input from said display input means to predetermined initial values upon operation thereof.

37. A group registering method for image output devices in an image output system, wherein the image output system includes a plurality of image output devices connected to a network, with each image output device having a plurality of attributes, the method comprising:
searching for image output devices having a designated attribute; and
grouping the image output devices searched on the basis of information for group instruction and registration of said image output devices.

38. The group registering method of claim 37, wherein searching for image output devices having the designated attribute is performed on the basis of pre-stored attribute information or detected attribute information of each of said image output devices.

39. An image output system comprising:
a plurality of image output devices each of which is connected to a network and outputs an image on the basis of image data transmitted through said network;
an image input device connected to said network, the image input device including a image data input portion for inputting the image data, a display input portion for inputting information for indicating a search condition for image output devices and information for instruction of selective grouping of image output devices satisfying the search condition, and transmitting/receiving portion for transmitting the image data input from said image data input portion and the information input from said display input portion and receives the attribute information of image output devices satisfying the search condition; and
a managing device that is connected to said network searches said plurality of image output devices for those satisfying the search condition, and registers image output devices as a group according to the information for instruction of selective grouping.

40. An image input device for use in an image output system including a plurality of image output devices each of which is connected to a network and outputs an image on the basis of image data and an output format transmitted through said network, and a managing device that is connected to said network, searches said image output devices on the basis of attribute information of each of said image output devices for those satisfying a search condition, transmits the attribute information of the image output devices searched through said network and registers the image output devices on the basis of information for instruction of grouping, the image input device comprising:
an image data input portion for inputting image data;
a display input portion for inputting information for displaying a search condition for said image output devices and information for instruction of selective grouping of image output devices satisfying the search condition, and displaying the attribute information of said image output devices satisfying the search condition; and
a transmitting/receiving portion that is connected to said network, transmits the image data input from said image data input means through said network, and the information input from said display input means and receives the attribute information of said image output devices satisfying the search condition.

41. A managing device for use in an image output system having a plurality of image output devices each of which is connected to a network and outputs an image on the basis of image data transmitted through said network, the managing device comprising logic for inputting information for indicating a search condition for said image output devices and information for instruction for selective grouping of image output devices satisfying the search condition, and further searching of image output devices satisfying the search condition on the basis of attribute information of each of said image output devices, and transmitting the attribute information of said image output devices thus further searched, and registering image output devices as a group on the basis of the information for instruction of selective grouping.

42. A group registering method for a plurality of image output devices connected to a network in an image output system, wherein the image output devices output images on the basis of image data, and the image output system includes an image input device for inputting the image data, and a display input device for inputting information for indicating a search condition for said image output devices and for inputting information for instruction of selective grouping of image output devices satisfying the search condition, and displaying attribute information of said image output devices, and a managing device for managing the attribute information of each of said plurality of image output devices, the method comprising the steps of:
transmitting from said image input device to said managing device the information representing the search condition for said image output devices input from said display input device;
searching for image output devices satisfying the search condition on the basis of each of the attribute information of said plurality of image output devices and transmitting the attribute information of said image output devices thus searched to said image input device in said managing device;
displaying the attribute information of said image output devices satisfying the search condition on said display input device and transmitting to the managing device information for instruction of selective grouping of image output devices satisfying the search condition input to said image input device; and
registering said image output devices as a group according to the information for instruction of selective grouping.

43. An image input device for use in an image output system, wherein the image output system includes image output devices and an image output managing device that is connected to a network, separates slave jobs from a master job with the slave jobs transmitted through said network and mutually associated with one another, and transmits the slave jobs to a designated image output device, and each of image output device is connected to said network, and executes the slave jobs transmitted from said image output managing device through said network, the image input device comprising:
an image data input device for inputting image data to execute as the slave jobs;
a display input device for receiving information for indicating an image output device to execute the slave jobs, setting the output processing based on image data input from said image data input device as the master job while setting output processing from a designated output device as slave jobs derived from the master job, issuing the master job and the slave jobs while mutually associating the master job and the slave jobs, and displaying the master jobs and displaying a list of the slave jobs associated with the master job in accordance with the operation of the master job when a job status is checked; and
a transmitter that is connected to said network, and transmits the information input from said display input device and the master job and the slave jobs to said image output managing device through said network.

44. An image input device for use in an image output system, wherein the image output system includes image output devices and an image output managing device that is connected to a network, separates slave jobs from a mutually-associated master job and slave jobs transmitted through said network and transmits the separated slave jobs to a designated image output device, and each image output device is connected to said network and executes the slave jobs transmitted from said image output managing device through said network, the image input device comprising:
an image data input device for inputting image data for execution as the slave jobs;
a display input device for receiving information to designate a slave job executing output device and a command for the master job and the slave jobs, setting the output processing based on the image data input from said image data input device as a master job while setting the output processing from the designated image output device as slave jobs derived from the master job, and issuing the master job and the slave jobs while associating the master job and the slave jobs; and
a transmitter that is connected to said network and transmits the information input from said display input device and the master job and the slave jobs through said network to said image output managing device.

45. The image input device of claim 44, wherein a command to the master job is made effective for the master job and the slave jobs, and a command to the slave jobs is made effective for only the slave jobs.

46. The image input device of claim 44, wherein the command is to instruct start, stop, resume, change or cancel a job.

47. The image input device of claim 43, wherein the master job and the slave jobs are associated with identification information for identifying an inputting user.

48. The image input device of claim 44, wherein the master job and the slave jobs are associated with identification information for identifying an inputting user.

49. An image output system comprising:
an image output managing device that is connected to a network, separates slave jobs from a mutually-associated master job and slave jobs transmitted through said network and transmits the separated slave jobs separated to a designated image output device;
a plurality of image output devices each of which is connected to said network and executes the slave jobs transmitted from said image output managing device through said network;
an image data input device for inputting image data for execution as the slave jobs;
a display input device for receiving information to designate a slave job executing image output device, setting the output processing based on the image data input from said image data input device as a master job while setting the output processing from a designated image output device as slave jobs derived from the master job, issuing the master job and the slave jobs while mutually associating the master job and the slave jobs with one another, and displaying the master job and displaying as a list the slave jobs associated with the master job in accordance with the operation of the master job when a job status is checked; and
a transmitter that is connected to said network and transmitting the information input from said display input device and the master job and the slave jobs through said network to said image output managing device.

50. An image output system comprising:
an image output managing device that is connected to a network, separates slave jobs from a mutually-associated master job and slave jobs transmitted through said network and transmits the separated slave jobs to a designated image output device;
a plurality of image output devices each of which is connected to said network and executes the slave jobs transmitted from said image output managing device through said network;
an image data input device for inputting image data to execute as the slave jobs;
a display input device for receiving information to instruct a slave job executing image output device and commands for the master job and the slave jobs, setting as a master job the output processing based on the image data input from said image data input device while setting the output processing from a designated image output device as slave jobs derived from the master job, and issuing the master job and the slave jobs while mutually associating the master job and the slave jobs with one another; and
a transmitter that is connected to said network and transmits the information input from said display input device and the master job and the slave jobs through said network to said image output managing device.
